(19) United States
(12) Patent Application Publication
(10) Pub. No.: US 2022/0129988 A1
(43) Pub. Date: Apr. 28, 2022

(54) SYSTEM AND METHOD FOR GENERATING INDICATORS DERIVED FROM SIMULATED PROJECTIONS INCORPORATING FINANCIAL GOALS

(71) Applicant: Banque Nationale du Canada, Montreal (CA)

(72) Inventors: Christophe FAUCHER-COURCHESNE, Montreal (CA); Simona GANDRABUR, Laval (CA); Pierre LAROCHE, Montreal (CA); Bryan MONCHAMP, Winnipeg (CA); Nada NAJI, Montreal (CA); Chelsey RIEGER, Winnipeg (CA); Eric-Olivier SAVOIE, Montreal (CA); Karine YELLE, Montreal (CA); Roger MILLER, Montreal (CA)

(73) Assignee: Banque Nationale du Canada, Montreal (CA)

(21) Appl. No.: 17/511,945

(22) Filed: Oct. 27, 2021

Related U.S. Application Data
(60) Provisional application No. 63/151,967, filed on Feb. 22, 2021.
(60) Provisional application No. 63/106,609, filed on Oct. 28, 2020.

(51) Int. Cl. G06Q 40/06; G06N 20/00; G06Q 40/08

(52) U.S. Cl. CPC G06Q 40/06; G06Q 40/08; G06N 20/00

(57) ABSTRACT

A method, a processing device and a computer-readable medium are provided for generating an indicator of the likelihood that an individual will achieve one or more financial life goals. The indicator of the likelihood that the individual will achieve the goal(s) according to the given scenario is calculated, based on a plurality of simulated financial projections. The indicator is displayed on a graphical user interface. Also proposed is a method and a system which generate customized financial products that allow individuals to achieve their respective life goals. The customized financial products are determined such that cash flow projections for the individuals remain positive for their entire lifetime and such that an indicator of the likelihood that the individual will achieve their life goals stays above a predetermined threshold.

### RELATED APPLICATION

The present application claims the benefit of U.S. Provisional Application No. 63/106,609 filed Oct. 28, 2020; and U.S. Provisional Application No. 63/151,967 filed Feb. 22, 2021, the entire disclosures of which are hereby incorporated by reference in their entirety.

### TECHNICAL FIELD

The technical field generally relates to methods and systems for wealth planning, and more specifically relates to a method and a system that provides a more accurate indicator of the likelihood that an individual will achieve his financial goals.

### BACKGROUND

It is known in the art that a projected cashflow can be calculated for a client. For instance, monthly spending and income can be identified and this data can be used to build a future cashflow projection for a client. With future estimates of income and monthly spending, the cashflow can stretch into retirement until an assumed date of death. Similarly, investments, debts and net wealth can be identified for a client and using assumptions for annual returns for different types of investments, a projection of future net wealth, cash and investment balance, and debt can be obtained.

It is also known that changes in any of the assumptions (monthly spending, monthly income, tax rates, types of investments, investment return rates, date of death, retirement date, etc.) will alter the estimated cashflows and projections of net wealth, cash and investment balances and debt.

Existing wealth planning software shows these cashflows and projections in the form of tables of numbers (year, income, spending, net, . . . ) or as a graph (income, spending, net wealth on the y-axis, time on the x-axis). The client may sometimes alter an assumption by, for example, entering a new number for the assumed return on investment, and the table of numbers or graph will update to show the new result.

There is still a need for more robust methods and systems that can simulate, with more accuracy and within a reasonable timeframe, financial projections. There is still a need for these systems and method to generate indicators that provide a better overview of the likelihood that an individual will achieve his financial goals.

For scenarios where cash flow projections are negative for a time, there is a need for systems and methods that can help alleviate these situations.

### SUMMARY

According to an aspect, a computer-implemented method is provided, for generating an indicator of the likelihood that an individual will achieve his financial goals. The method comprises receiving, at a communication interface of a computer-implemented simulation system, an electronic request from a financial planning application running on a remote device. The request is for receiving financial projection data, based on the financial goals of the individual and for receiving the associated indicator. Upon receiving the electronic request, the simulation system retrieves, via a querying module, from a data storage: financial goal entries associated with the individual, each financial goal entry comprising a time value and a financial value characterizing an expense associated with the financial goal, and a set of assumption values that determine projected incomes and projected expenses of the individual. The method also comprises retrieving, via connectors of the computer-implemented simulation system in communication with different data sources, financial data associated with the individual. The financial data comprises current account balances, historical income data and historical expense data. One or more processing devices of the computer-implemented simulation system then concurrently simulate a plurality of financial projections over a given time interval. The financial projections are simulated using the time and financial values of the financial goal entries and using the financial data retrieved from the different data sources. Each financial projection is simulated by applying a variation on the set of assumptions values. The processing devices of the simulation system determine, for each financial projection of the plurality of financial projections, whether a net balance is positive or negative over all periods of the time interval. The processing devices then calculates the indicator of the likelihood that the individual will achieve the financial goals, based on the plurality of financial projections simulated. The indicator is indicative of a number of financial projections simulated for which the net balance is positive, over the plurality of financial projections simulated. The computer-implemented simulation system then outputs, via a communication interface, the indicator and the financial projection data combining the plurality of financial projections simulated to the financial planning application of the remote device, for display in a graphical user interface on the screen of the remote device.

According to possible implementations, the indicator is expressed as a percentage or a ratio of the number of financial projections for which the net balance is positive, over the plurality of financial projections simulated.

According to possible implementations, the given time interval spans over several years. Simulating the plurality of financial projections can be performed for each year of the time interval, wherein for a given year, the financial value of one of the financial goal entries is added to the financial projection simulations if the time value of said one entry falls within the given year.

According to possible implementations, applying the variations on the set of assumptions values is performed using a Monte Carlo simulation.

According to possible implementations, the method comprises a step of retrieving, from the data storage, weights associated with the financial goal entries. In this case, simulating the financial projections comprises adjusting the financial values associated with the financial goal entry as a function of the weight of said entry.

According to possible implementations, the financial goal entries are classified according to different goal types, each goal type being associated with a corresponding weight.

According to possible implementations, the method comprises as step of associating, by the one or more processing devices, indicator thresholds with the different goal types, the indicator being expressed as a joint probability that all indicator thresholds will be met for the financial goals entries.

According to possible implementations, the weight associated with a financial goal entry is based on a degree of commitment associated with said financial goal. The degree of commitment can be determined by the one or more processing devices of the computer-implemented simulation system, based on the historical income data and historical expense data.

According to possible implementations, the step of determining the degree of commitment associated with the financial goals is performed using a trained machine learning model.

The degree of commitment corresponds to a predicted probability outputted by the trained machine learning model that a specific financial goal will be achieved, the historical income data and historical expense data being inputted to the trained machine learning model.

According to possible implementations, the set of assumption values is associated with a first scenario. The method may further comprise a step of displaying, by the financial planning application of the remote device, in the graphical user interface, a graph representative of the combined financial projections simulated and associated with the first scenario. The method can also include a step of capturing, by the financial planning application of the remote device, via the graphical user interface, a selection of a second scenario, the second scenario comprising a change in at least one of the assumption values of the set of assumption values associated with the first scenario. The financial planning application of the remote device then sends, to the computer-implemented simulation system, an updated electronic request for updated financial projection data and for an updated indicator. Upon receiving the updated electronic request, the computer-implemented simulation system automatically re-simulates the financial projections according to the second scenario and updating the indicator and outputs, via the communication interface of the computer-implemented simulation system, the updated indicator and the updated financial projection data to the financial planning application of the remote device. The financial planning application of the remote device displays, in the graphical user interface, the graph of the first scenario and a graph of the second scenario, as well as the updated indicator, indicating the effect of the second scenario on the likelihood of achieving the financial goals.

According to possible implementations, the change comprises changing at least one of: an investment return rate; a risk profile associated with the individual; a retirement date and a life expectancy.

According to possible implementations, the financial planning application of the remote device captures, via the graphical user interface, a variation interval to use when applying the variations on the set of assumptions values. The variation interval comprises a lower bound and an upper bound determining the scope of the variations to apply when simulating the financial projections. The effect of the variation interval on the first or second scenarios for which the variation interval has been captured are then simultaneously displaying on the graphical user interface, while still displaying the initial first and second scenarios.

According to possible implementations, the financial projections simulated comprises cash flow projections and/or a balance or net worth projections, wherein the net balance corresponds to a value of the estate at an assumed year of death of the individual.

According to possible implementations, the method comprises a step of determining, by the one or more processing devices, for years of the time interval during which the net balance is negative, a modification to the time or the financial values of the financial goal entries, the projected incomes or the projection expenses, that will increase a value of the indicator. The processing devices of the simulation system are configured to generate a financial advice, based on the modification determined and to send an electronic notification to the financial planning application of the remote device that comprises the financial advice.

According to possible implementations, the step of generating the financial advice comprises a step of automatically determining a loan amount and interest rate that allow the simulated financial projections to remain positive for all years of the given period.

According to another aspect, a system for generating the indicator is provided. The system comprises a computer-implemented simulation system, comprising one or more processing devices; a communication interface for communicating with financial planning applications running on remote devices, a querying module in communication with a data storage; and connectors in communication with different data sources. The computer-implemented simulation system is adapted to perform the steps of the method defined above.

According to possible implementations, the system comprises a Monte Carlo module comprising a set of computational algorithms for simulating the plurality of financial projections for the plurality of individuals.

According to possible implementations, the system comprises the data storage for storing the financial goal entries of a plurality of individuals and for storing respective weight values associated therewith. The computer-implemented simulation system is also configured to calculate the indicator as a function of the different weights associated with the financial goals entries.

According to possible implementations, the system comprises a machine learning model trained to determine a degree of commitment associated with the financial goals by outputting a predicted probability that a specific goal will be achieved, the historical income data and historical expense data being inputted to the trained machine learning model.

The computer-implemented simulation system is configured to simulate the financial projections further based on the degree of commitment associated with the financial goals.

According to possible implementations, the system comprises the plurality of remote devices running the financial planning applications. The remote devices are configured to display, on a corresponding one of the remote devices, a graph representative of the set of financial projections associated with a first scenario, the set of assumption values being associated with the first scenario. The remote devices are also configured to receive a selection of a second scenario, the second scenario comprising a change in at least one of the assumption values of the set of assumption values associated with the first scenario.

The computer-implemented simulation system is configured to automatically re-simulate the financial projections according to the second scenario and update the indicator. Each of the remote devices is further configured to display the graph of the first scenario and a graph of the second scenario in the graphical user interface, as well as the updated indicator.

According to possible implementations, each of the remote devices is configured to capture a variation interval associated with the first or second scenarios, the variation interval comprising a lower bound and an upper bound. Each remote device is also configured to simultaneously display the effect of the variation interval on the scenario for which the variation has been captured, while still displaying the initial first and second scenarios.

According to possible implementations, the computer-implemented simulation system is configured to determine, for years during which the indicator falls below a predetermined threshold, a modification to the time or the financial values of the financial goal entries, the projected incomes or the projection expenses, that will increase the likelihood of achieving the finance goals.

According to possible implementations, the computer-implemented simulation system further comprises a finance advice module configured to generate financial advice based on the change(s) determined; and a notification module for sending an electronic notification to the financial planning application of the remote device comprising the financial advice.

### BRIEF DESCRIPTION OF THE DRAWINGS

FIG. 1 is a schematic diagram of a computer-implemented simulation system and of a method for generating financial projections according to different scenarios and for generating an indicator of the likelihood that the individual will achieve one or more life goals. The system and method can also generate customized financial products that are based on the life goals and indicator of the individual.

FIG. 2 is a schematic diagram of the computer-implemented simulation system of FIG. 1, including an overview of the different components and data sources of the system.

FIG. 2A a schematic diagram of the computer-implemented simulation system of FIG. 1, according to a different embodiment, including a general workflow diagram of the steps for generating customized financial products, according to a possible implementation.

FIG. 3 shows a graphical user interface (GUI) generated a financial planning application running on a remote device, allowing users to create, manage and update different types of financial goals. FIG. 3 also shows exemplary data structures or entries of financial goals.

FIG. 4 shows a graphical user interface (GUI) generated by the system, allowing users to create, manage and update different assumptions used in generating the financial projections and the indicator.

FIGS. 5A, 5B and 5C are different views of the graphical user interface (GUI), displaying financial projections according to different scenarios, for different related individuals, and showing how variations in financial projections affect the likelihood of achieving the one or more financial goals set by the individual(s).

FIG. 6 is another view of the graphical user interface (GUI), showing how small variations on parameters affect the financial projection of a given scenario.

FIGS. 7A, 7B and 7C are different views of the graphical user interface (GUI), displaying financial projections with different levels of details.

FIG. 8 is a flow chart of a computer-implemented method for automatically generating a customized loan offer that allows cash flow projections and/or a life-goal indicator to stay above a predetermined threshold, according to a given scenario.

FIG. 9 is a flow chart of computer-implemented method for automatically generating a customized life insurance offer that allows cash flow projections and/or the life-goal indicator to stay above a predetermined threshold, according to a scenario in which one of the spouses of a household passes away.

FIG. 10 is a flow chart of a computer-implemented method for automatically determining the termination date of a life insurance contract, while keeping the cash flow projections and/or the life-goal indicator above a predetermined threshold, according a given scenario.

FIG. 11 is a flow chart of a computer-implemented method for automatically generating a customized life insurance offer, while keeping cash flow projections and/or the life-goal indicator above a predetermined threshold, according a given scenario.

FIG. 12 is a flow chart of a computer-implemented method for automatically identifying listings of real estate properties that an individual can likely buy, while keeping cash flow projections and/or life-goal indicator above a predetermined threshold, according to a given scenario.

### DETAILED DESCRIPTION

In the following description, similar features in the drawings have been given similar reference numerals and, to not unduly encumber the figures, some elements may not be indicated on some figures if they were already identified in a preceding figure. It should be understood herein that the elements of the drawings are not necessarily depicted to scale, since emphasis is placed upon clearly illustrating the elements and interactions between elements.

The present description is directed to a computer implemented method and to a computer-implemented simulation system that can concurrently simulate a plurality of financial projections and that can generate an indicator of the likelihood that an individual, also referred to as a client, will achieve one or more financial goals, based on the simulated projections. The proposed system and method allow to factor in parameters associated with financial goals when simulating financial projections. The algorithms of the proposed system can concurrently simulate a large number of financial projections based in the financial data of an individual, by applying slight variations on a set of assumptions, resulting in an indicator that better reflects the possible variations that can occur in an individual's lifetime. The description is also directed to tools that allow visualizing the impact of life events and choices that individuals may make on their financial goals. Broadly, a financial goal can correspond to savings objectives or desired financial outcomes in life.

In the description below, the life events and life goals can be translated in “financial goals” and correspond to events/goals having an impact on financial means or needs of a client. Financial goals can be represented as electronic data structures or entries, that include time parameters, such as specific dates or periods, and by financial parameters, such as expenses and interest rates.

More specifically, life events or life goals can include: changing/starting/losing job; moving to a foreign country; starting/ending studies; purchasing/leasing/selling a real estate property; a sudden accumulation of capital (bonus payment, inheritance, lottery win, etc.); reaching retirement; the birth of a new child, a divorce; etc. Life goals can include retiring at a given age, buying a new house, a cottage or a sports car, renovating a house, sending children to a private college, etc. It will be appreciated that some of these examples can be a life event for one client but a life goal for another client, depending on whether they are an objective of the client's or they actually occurred, while other examples are exclusively life events or goals. Moreover, life goals, once attained, can become life events for the client.

As mentioned above, life goals and life events can be expressed as financial goals characterized by time and financial values. A financial goal entry or record can be stored in memory and processed by algorithms as one or several related data structures. For example, the life goal “buying my first house” can be characterized by a “time parameter”, corresponding to the year when the client wishes to buy his first house, and a “financial parameter” corresponding to the range of prices the client is considering paying for his first house. Life goals can therefore be treated as liabilities for financial planning purposes. More than one time and/or financial values can be associated with financial goal. For example, the financial goal of buying a new house can be associated with a down payment at a time Ti, and monthly payments for X number of months. Life goals may also be classed by importance to the client. For instance, goals may be classed as needs, projects or dreams, where needs are necessities to the client, projects are less important and dreams are least important. For example, purchasing a replacement car in order to commute to work may be a need, but buying a sports car in retirement may be a dream. Other terms may be used to describe such classes and more or less classes may be used. Alternatively, goals may be ranked by the client in order of importance. Based on the type of goal set by the individual, weights can be added to, or associated with, the financial goal entries. In possible implementations, the financial goal entries can be classified according to different goal types (such as dreams, projects or need), each goal type being associated with a corresponding weight.

Financial projections, such as projected cashflow or projected balance, can be simulated by the computer-implemented simulation system based on the financial goals of the individuals. Preferably, the computer-implemented simulation system concurrently simulates, by one or more processing devices (such as physical or virtual servers), a plurality of financial projections over a given time interval. The time interval can be set through the graphical user interface (GUI) of a financial planning tool. For example, a time interval can correspond to the period between the current date or year and the assumed year of death of the individual. The financial projections are simulated using the time and financial values of the financial goal entries and also using financial data associated with the individual, that is retrieved by the system from the different data sources. The data sources can be different databases, that store data on accounts, investments, and loans of the individual.

For instance, the computer-implemented simulation system retrieves, using different connectors, web services and Application Programming Interfaces (APIs), from various data sources, financial data, such as monthly expenses and incomes, associated with accounts of the individual. In addition, costs of life events and life goals can be estimated or captured through a GUI and converted as financial parameters of the financial goal entries. These data can be used to simulate a cashflow projection for a client into the future. With future estimates of income (from all sources) and monthly spending, the cashflow can stretch into retirement and an assumed date of death (called below “cashflow projections”). Similarly, investments, debts and net wealth can be retrieved for a client and using assumptions for annual returns for different types of investments, fees and taxes, a projection of future net wealth, cash, debt, asset and investment balance values (called below “financial projections”) can be obtained.

An “indicator” (or “life goal indicator”) comprises different means to indicate the likelihood that the client will achieve his life goals during his lifetime. The indicator can be expressed as a colour-coded icon or a visual representation (green—good, red,—unlikely, orange—somewhat unlikely) or it can be expressed as a number between 1 and 100 or 0% and 100%, expressing this probability. Other ways of communicating the indicator are possible. The indicator is a measure of whether upon death, an individual generated enough income vs spending to achieve all his financial goals, including possibly leaving an estate for survivors. Because the cashflow and balance projections depend on future income and expenses and return rates on investments, the indicator is a probability and can depend strongly on changes in the initial assumptions. In particular, retirement dates, investment returns, and assumed dates of death affect the indicator value strongly. Alternatively, a client may have several indicators, for instance one for client life attributes that are very important to the client, and another for client life attributes that are less important. These indicators may be calculated and displayed individually as described above.

It is known that variations in any of the assumptions (monthly spending, monthly income, tax rates, types of investments, investment return rates, dates of death, retirement dates, etc.) will alter the estimated cashflows and projections of net wealth, cash and investment balances and debt. The proposed system and method go further in that they provide an indicator of the likelihood that all financial goals set for a given client will be achieved, based on financial data associated with the client, based on a set of assumptions, and based on life attributes. Moreover, in order to provide a more accurate and robust indicator, a plurality of financial projections is preferably concurrently simulated, by applying variations for each simulation on the set of assumptions values. By simulating a large number of financial projections that factor in the financial goals of the individual, such as over 100, and preferably over 500, the indicator generated is more representative of the likelihood that the financial goals will be achieved. Virtual machines can be used to concurrently simulate the financial projections, such that the waiting time for receiving a combined projection derived from the multitude of simulations and the indicator is within an acceptable timeframe, i.e., less than a few seconds.

The term “financial data” refers to income data, expense data, financial transactions data, spending habits, saving habits, investment transactions data, account balance data (including checking, savings, investment, credit, and loan account balances) net estate data or net wealth data. The financial data can be collected from different sources, such as check and saving accounts, line of credit accounts, mortgage accounts, Registered Retirement Savings Plan (RRSP) accounts, Tax Free Saving accounts (TFSA), credit card accounts, retirement accounts, investment accounts, tax levels, social insurance programs, governmental pension plans or other supplementary allowance, etc.

The term “assumption” refers to the values that are needed to calculate the financial projections and that are likely to vary. They can include sources of income including base salary, a yearly bonus, real estate income, government transfers, etc. (before and after retirement); expenses (before and after retirement); inflation; investment return forecasts and associated uncertainties (leptokurtic distribution); a retirement age; last year of financial and cashflow projection (i.e. year of death); etc. The assumptions can be associated with a client, a household or another entity, such as a company.

The term “scenario” (or “finance scenario”) refers to a set of assumptions and financial data that are used to calculate the financial projections and the indicator(s), as well as the values of the financial projections and the indicator(s).

The term “individual”, or “client” refers to the person for which the financial projections are generated, and whose financial data is used. A client can also be characterized by different parameters, which can be stored, accessed and processed as a set of data structures, for holding the client's personal information (gender, address, workplace, age, marital status, kids, etc.), their socio-economic demographics (of their neighbourhood, their income bracket, their education, etc.), their financial status (net wealth, investments and cash, debts), their financial transactions (income, expenses, spending habits), their personal preferences, and their behavioural profile (risk propensity, personality, etc.).

The term “user” refers to end users of the financial planning software application and of the graphical user interfaces of the proposed system. A “user” can correspond to the client for which the indicator(s) is estimated or predicted, but not necessarily, since a user can also be the financial advisor of the client.

Data structures (also referred to as data records or data entries) can be stored for variable periods, from months to a few microseconds, as they are continuously updated, and can be transmitted or saved in database tables, arrays, files (such as ASCII, ASC, .TXT, .CSV, .XLS, etc.) and can transit in memory, such as registers, cache, RAM or flash memory, as examples only. The different fields can include numeral, date or character values.

The term “processing device” encompasses computers, servers and/or specialized electronic devices which receive, process and/or transmit data. “Processing devices” are generally part of “systems” and include processing means, such as microcontrollers, microprocessors or CPUs, are implemented on FPGAs, as examples only. The processing means are used in combination with storage medium, also referred to as “memory” or “storage means”. Storage medium can store instructions, algorithms, rules and/or trading data to be processed. Storage medium encompasses volatile or non-volatile/persistent memory, such as registers, cache, RAM, flash memory, ROM, as examples only. The type of memory is of course chosen according to the desired use, whether it should retain instructions, or temporarily store, retain or update data. Steps of the proposed method are implemented as software instructions and algorithms, stored in computer memory and executed by processors. It should be understood that servers and computers are required to implement the proposed system, and to execute the proposed method.

The term “system” refers to a computer-implemented system which comprises different hardware components (servers, databases, routers) and software modules (referred hereafter as “modules”) or software applications. Each module comprises a set of software functions, each comprising program code that when executed will provide the intended functionality, including for example running queries, calculating different financial parameters, comparing values, outputting parameters, etc. The modules interact with different databases or data sources. The different modules are further configured to communicate with other software modules and/or with other components of the system 10, for example via APIs.

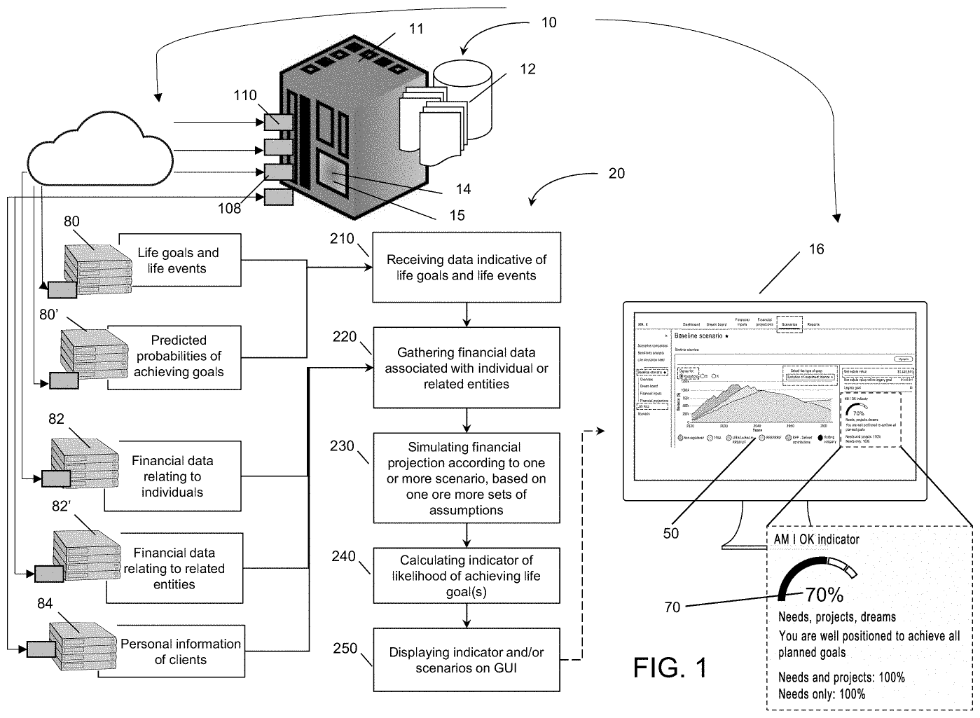

Referring to FIG. 1, a system 10 for generating an indicator of the likelihood that an individual, or client, will achieve one or more life goals is schematically illustrated. The steps of the method 20 implemented by the system 10 are also provided in a flow chart. The system 10 comprises one or more processing devices 11, such as servers, and data storage 12, including databases. The system 10 comprises a querying module 110 for retrieving data indicative of one or more financial goals associated with the individual (step 210), connectors 108 to gather financial data associated with the individual (step 220), a financial projection and indicator calculation module 14, to calculate financial projections and the indicator (steps 230, 240), a customized financial product module 15 and a graphical user interface (GUI) 16, that can be generated by a financial planning application running (or accessed) on remote processing devices of users, to capture assumptions and/or variation on assumptions used in calculating the financial projections and the indicator, and for displaying the indicator (step 250). The financial planning application 150 can be a web-based application accessed via a secured connection by a remote device. The GUI 16 can display additional information, such as the financial goals and their associated parameters, different types of graphs, such as cash flow and balance projections, as well as financial advices and financial product offers, tailored for the individual, as a function of his financial goals. Input modules and connectors can comprise both hardware and software components to connect, retrieve or receive data. The financial projection and indicator calculation module 14 can be configured to calculate cash flow projections and financial projections.

As explained above, financial goal entries comprise at least one time-related value and one financial-related value. A typical financial goal, such as retiring at 65 years old, can be stored in the present system as a data structure which comprises one or more time parameter(s), including for example the retirement year and the assumed year of death, and different financial parameters, such as the estimated expenses during the retirement period. A financial goal entry can include other types of parameters, such as the goal type (dream, need, project), the weight or importance of the goal compared to other goals, and the likelihood or probability that the goal will be reached by the individual (i.e. specific financial goal indicator). Similarly, a life event can be stored and processed as financial goal entry, also characterized by time and financial parameters. A life event can be the purchase of a first home, the date or year of the purchase (time parameter), and the cost of the home and the value of the mortgage (financial parameters). Different financial goal entries can be created, stored and updated, each having their own specific data structures, with their own fields.

Financial goal entries can be stored and managed on data storage 80, external to the system 10, or it can be stored in data storage that is part of the system 10. The financial goal entries for a given individual can be obtained via different applications, such as via a financial planning software application used by financial advisers, when they meet or call their clients during annual or follow-up meetings; via customer service applications, used by call center agents, or they can be obtained by the clients themselves, via the graphical user interface of an end-user application, in which each client can input their own life goals. The software applications and platforms from which life goals and life events can be obtained, may, in some implementations, be driven by machine learning models. The machine learning models can be trained to predict life goals or life events of clients, based on their financial data, and other personal data.

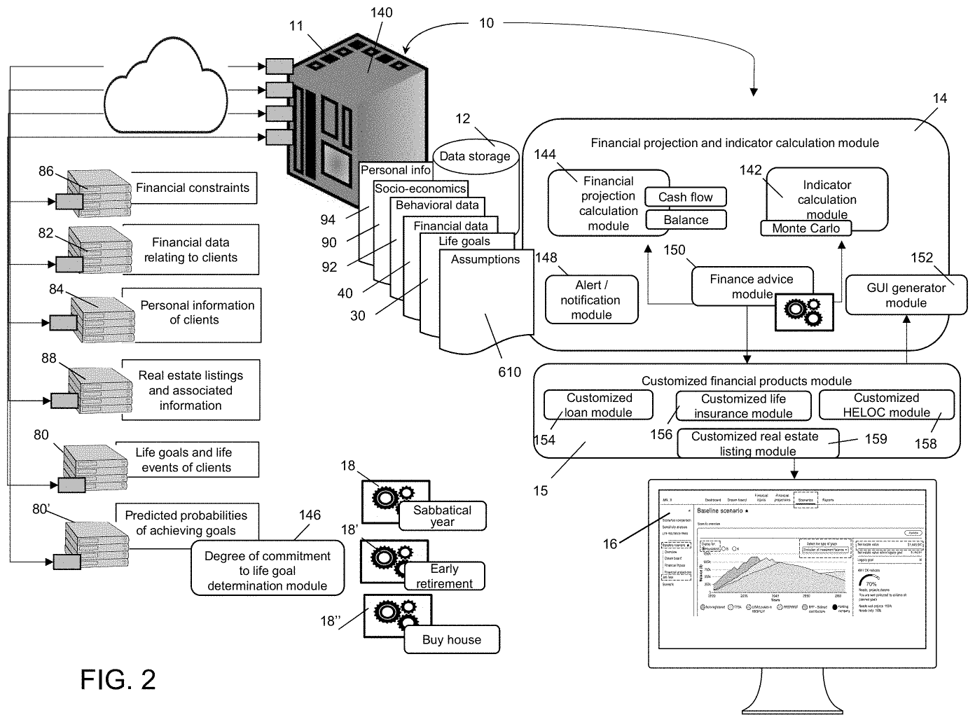

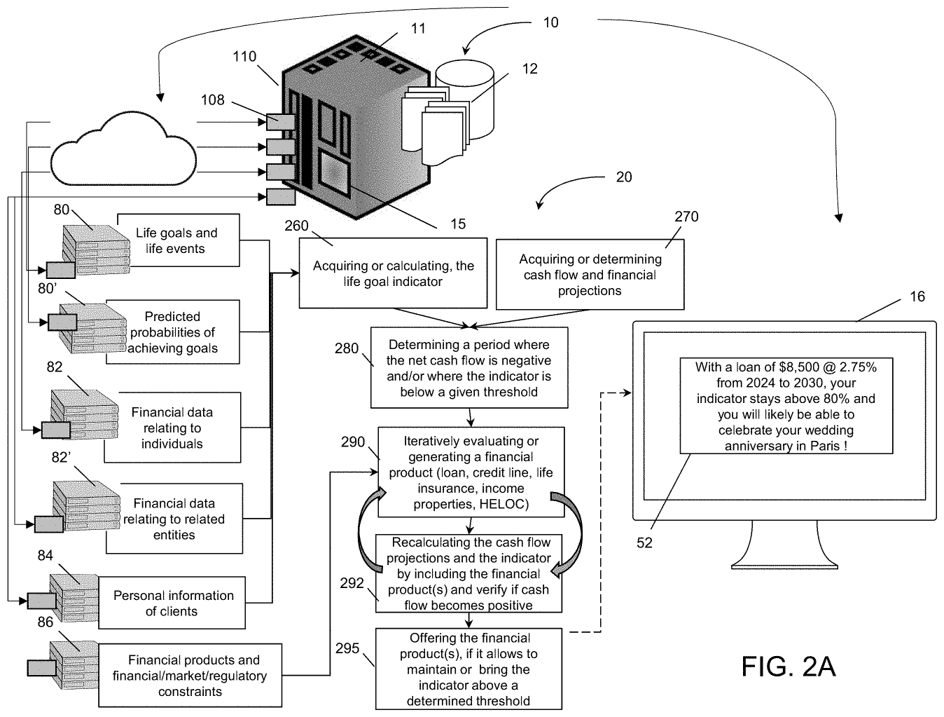

When performed the proposed method, a communication interface 140 (identified in FIG. 2) of the computer-implemented simulation system 10 receives an electronic request from a financial planning application running on a remote device for financial projection data, based on the financial goals of the individual and for the associated indicator. Upon receiving the electronic request, the computer-implemented simulation system retrieves, via a querying, from a data storage financial goal entries associated with the individual and a set of assumption values that determine projected incomes and projected expenses of the individual.

Still referring to FIG. 1, the connectors 108 can connect to a plurality of data sources 80, 80′, 82, 82′, 84 to gather personal and financial data associated with the individual (step 220), including current account balances, historical income data and historical expense data. By historical income and expense data, it is meant the incomes and expenses passed in the accounts of the individual prior to the date when conducting the simulations. The connectors are adapted to connect to databases to access financial data from accounts linked to the individual or one of its entities (such as spouse, companies or trusts). The term “connector” encompasses physical and/or software ports and Application Programming Interfaces (APIs) used to connect to the sources of financial information, such as servers and databases. As will be explained in more detail below, the proposed system can calculate the financial projections and the indicator of the likelihood of achieving goals, not only for a single individual, but also advantageously for his household, by considering the financial data of his/her spouse or partner, children and also for companies owned by the individual. The income data can be gathered from check and saving accounts, retirement savings plan accounts, tax-free saving accounts, etc. The expense data can be gathered from credit card, checking and line of credit accounts, mortgage account and car loan account, as examples only.

The financial projection and indicator calculation module 14 comprises different sub-modules, with functions and algorithms to simulate the different types of financial projections (cash flow, balance, net worth, etc.), according to different scenarios. By “simulating”, it is meant that the module iteratively calculates the balance, for all periods of a given time interval, based on all the financial data retrieved or estimated for the individual, and also based on the financial goal entries. The given time interval spans over several years, such that simulating the plurality of financial projections can be performed for each year of the time interval; and wherein for a given year, the financial value of one of the financial goal entries is added to the financial projection simulations if the time value of said one entry falls within the given year. For each financial projection of the plurality of financial projections, and for each period of the time interval, the processing devices determine whether a net balance is positive or negative over all periods of the time interval.

The scenarios are a function of the financial data gathered; of the financial goal entries and are also a function of a set of assumption values that determines projected incomes and projected expenses (step 230). A baseline scenario can use, for example, a first client life goal of the individual retiring at 65 years old, and a second, different scenario may use a second client life goal of the individual retiring at 60 years old. Each scenario, as explained above, can be stored as one or more data structures with different fields, including a scenario name, and a set of assumption values, including for example an inflation rate, a return rate on the individual's investments, a salary increase rate, a retirement year, an assumed year of death, etc.

The financial projection and indicator calculation module 14 also comprises functions and algorithms to calculate the indicator 70 of the likelihood that the individual will achieve his life goal(s) according to a given scenario, based on the plurality of financial projection simulated (step 240). It is well known in the field of finance how to calculate different types of projections, such as cash flow projections, and financial projections. The system 10 and method 20 are an improvement over existing financial projection applications, in that it outputs an indicator indicating how likely it is that all goals set by the individual will be achieved, based at least on his/her financial data and a set of assumptions, that are slightly varied when concurrently simulating the financial projections. The indicator is calculated, based on the plurality of financial projections simulated. The indicator is indicative of a number of financial projections simulated for which the net balance is positive, over the plurality of financial projections simulated. The indicator can be expressed as a percentage or a ratio of the number of financial projections for which the net balance is positive over all periods of the time interval, over the plurality of financial projections simulated.

In the example of FIG. 1, the indicator 70 is expressed as a percentage value, indicating that the probability (70%) that his/her the life goals (including dreams, projects and needs) will be achieved. Alternatively, an indicator may be calculated for life goals that are needs, another indicator for life goals that are projects and a third indicator for life goals that are dreams. Indicator values may be different depending on the type of life goals. For example, in some circumstances, dream life goals may be more expensive than needs life goals, and therefore the indicator value for dream life goals may be lower than for needs life goals. As will also be explained in more detail below, the indicator can be updated, depending on the scenarios selected through the GUI 16.

The system 10 also comprises a graphical user interface (GUI) generator module 152 to generate a GUI 16. The GUI is used to capture the set of assumption values used for calculating the financial projections and the indicator. The GUI 16 also displays the indicator (step 250), and also preferably the financial projections, in a graph or table format. The communication interface of the computer-implemented simulation system 10 outputs the indicator and the financial projection data combining the plurality of financial projections simulated to the financial planning application 150 of the remote device, for display in a graphical user interface on the screen of the remote device.

Now referring to FIG. 2, a more detailed diagram of the system 10 is provided, in which the different elements of the “financial projection and indicator calculation module” 14 are shown: the financial projection simulation module 144, the indicator calculation module 142, the alert/notification module 148, the financial planning application module 150 and the GUI generator module 152.

In a preferred implementation of the system and method, the indicator calculation module 142 comprises sets of functions and algorithms that implement Monte Carlo simulations to calculate the indicator value, based on the set of assumptions. The simulation module concurrently simulates a plurality of financial projections, each time using a different set of assumptions values while considering each life goal. The simulation module processes the time and financial values of the financial goal entries and the financial data retrieved from the different data sources. Each financial projection is simulated by applying a small variation on the set of assumptions values. The distribution of projections at the assumed date or year of death of the client and each year of the financial projections determines a likelihood of achieving the client life goals used in calculating the cashflow projections.

The simultaneous or parallel simulations allows providing an indicator that is more robust and accurate that if only one or a few simulations were conducted, while providing the results in a reasonable timeframe in the GUI of remote devices of end users, such as in less than 10 sec, and preferably in less than 5 sec, and still preferably in less than 3 sec.

More specifically, the financial projections can be calculated by first identifying values for each assumption of a given scenario, where assumptions can include investment returns, inflation, etc. The identified values for each assumption can be a range of values, which can be based on an assumed leptokurtic distribution, as an example only. A debt threshold may also be identified. The debt threshold can be determined based on limits from lines of credit accounts and/or from credit card accounts, such that the debt threshold corresponds to the sum of the line of credit and credit card maxima. For example, it can be determined that for a given individual, the debt from lines of credit and credit cards should not exceed $50 k or that the total debt and mortgage amount should not exceed $500 k. In other cases, the debt threshold can be a multiple of the client's total annual income, such as not more than 5 times the total income. The interest rate used for debt calculations can be fixed or forecasted.

Next, the dates and cost of life goals are identified, from the values of the fields in the financial goal entries. Optionally, a ranking can be associated with the life goals, such as from most important to least important. If a ranking is used, weights will be associated to each life goal entry, and the weight is applied to the financial values associated to the financial goal entry. Simulating the financial projections may thus comprise adjusting the financial values associated with the financial goal entry as a function of the weight of the entry. The financial goal entries can be classified according to different goal types, such as need, project or dream. Each goal type can be associated with a corresponding weight, such as 100% for a need, 80% for a project and 60% for a dream.

The starting balances in all accounts are also determined: they can be collected from different financial data systems 82, 82′ or entered through the GUI. The starting balances can include cash amounts in checking and saving accounts, the debt amounts in loan and mortgage accounts, and the amounts investment accounts, such as from tax-free saving accounts and registered retirement saving plan or other investment accounts.

At this point, the total income and total expenses for the coming year can be computed. When calculating the financial projection for a given year, the expense associated with a financial goal entry is included if the goal occurs in the given year. Calculating the financial projections comprises computing interest to be paid on loan accounts (personal line of credit, mortgage, etc.) which can be computed using a risk premium over government debt interest rates and bootstrapping or keeping interest at current interest rate for the duration of the calculation. The financial projection calculation can also comprise computing taxes to be paid as part of expenses. Investment incomes are computed, based on starting balance in each investment accounts and using assumption for investment returns.

The net income (positive or negative) is computed based on income and expenses for the year. If the net income is positive, the amount in excess can be allocated according to a savings strategy, such as by investing in education or retirement saving plans, or in tax-free accounts, or by paying off debt. If the net income is negative, the balance of the individual's accounts can be reduced, according to a predefined order, such as on taxable (unregistered) accounts first, and then on company account, if applicable, then on tax advantaged (registered) accounts. If needed, the amount can be borrowed from loan accounts (credit cards or personal line of credit). The calculation process comprises updating the values of all accounts (such as cash, savings, investments, retirement, RESP, mortgages, loans, etc.) at end of year.

The calculation steps described in the last two paragraphs (i.e. net income calculations and updating account) are repeated for every year, until the year of the assumed death. After the estimated retirement year, the net income and expenses can be adjusted based on a different set of assumptions, for instance taking into account a decrease in income and expenses.

At the assumed year of death, the net wealth is computed, which correspond to the sum of all accounts, that is the addition of the remaining cash and investments minus the debts and taxes owed. The remaining amount is then compared to a bequest value. For example, the remaining amount can be compared to the bequest the client wishes to leave after all bequests in the clients' will are satisfied. If the remaining amount exceeds the bequest, then the indicator is indicative of this positive outcome. If the remaining amount is less than the desired bequest, then the indicator is indicative of this negative outcome/simulation. In possible embodiments, the indicator will also reflect whether the total debt in any one year is greater than the predetermined debt threshold. In such cases, the indicator can be indicative of a negative outcome for a given simulation, even if the desired bequest is met.

In possible implementations, the financial projections are calculated several times, each time applying a small variation to one of the assumptions, and each time determining whether the outcome (i.e. the net balance of a given year) is positive or negative. As mentioned above, the calculations can be run thousands of times, using the Monte Carlo simulation. According to this implementation, the indicator can be expressed as a percentage of the number of times the outcome of a given simulation is positive, over the total number of simulations. The indicator is thus indicative of a number of financial projections simulated for which the net balance is positive, over the plurality of financial projections simulated. For example, if 10,000 simulations are executed and the outcome is determined positive for 5,000 of the simulations, then the indicator value is 50%.

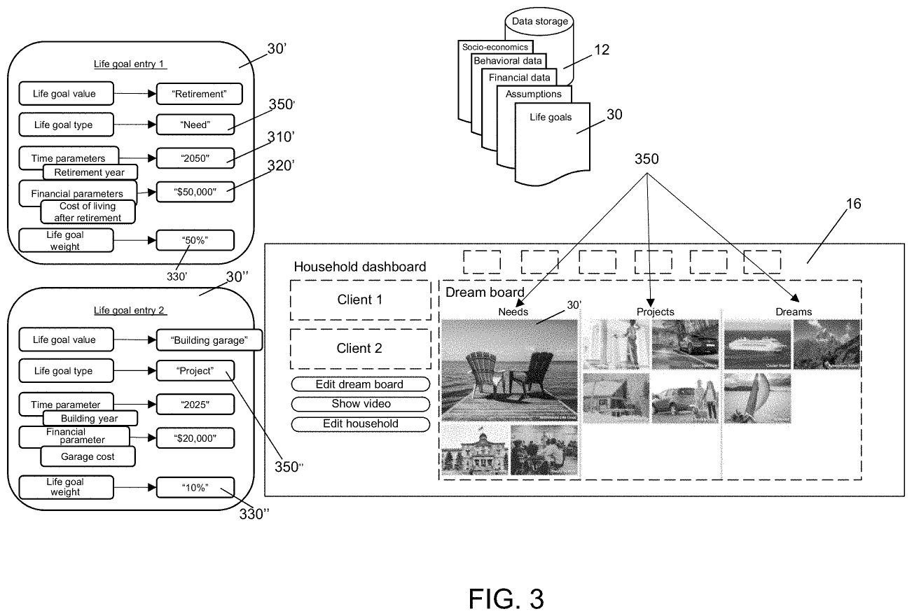

Still referring to FIG. 2, and to FIG. 3, the indicator can also be calculated as a function of weights or goal types associated with the life goals. In FIG. 3, the parameters characterizing the financial goal entries 30′, 30″ are stored in database 12, and each financial goal data entry comprises its own set of parameters. Two examples of entries 30′ and 30″ are schematically represented, where an entry can be characterized by time values 310′, financial values 320′ and goal type 350′ (such as a need, a project or a dream), as examples only. Yet in other implementations, the financial goal entries can be associated with respective weights 330′, wherein calculating the indicator is a function of the different weights associated with the life goals. The weight associated with a need can be higher than the weight associated with a project or a dream. The weight can be a percentage, or a ponderation used when calculating the overall indicator. In one possible implementation, the expense associated with a goal can be multiplied by a weight having a value between 0 and 1, depending on the importance of the goal. The weight is set according to the ranking previously determined, as explained above. For example, the $200 k cost of a sailboat at age 68, (dream) might be multiplied by 60% while the $25 k cost of a replacement vehicle to commute to work in year 3 (need) would be multiplied by 100%.

According to another implementation, the simulations described above can be conducted as many times as there are goals. For the first set of simulations, a first indicator is determined for the most important goal. A second set of simulations is then conducted, this time taking into account the first and second most important goals. The same process can be conducted until all goals have been taken into account. More specifically, the first indicator is determined based on a single goal (the most important), which will generally lead to an indicator with a high value (since there is only one expense associated with goals). For the second indicator, the first two most important goals are taken account—i.e. their associated expenses are included when calculating the financial projections, which will lead to an indicator with a lower value. This process is repeated until the last indicator includes all goals. The indicator reported to users can be an average of all indicator values calculated or it can be a weighted average to reflect the goal ranking.

Yet according to another possible implementation, three sets of financial projection simulations can be conducted, where each set corresponds to life goals having been classified with a different importance rank. For example, a first set of simulations can take into account only the goals classified as “needs”, a second set corresponds to goals classified as “projects” and a third set corresponds to goals classified as “dreams.” The indicators associated with each type of goal can be reported individually, or as a joint probability.

Yet according to another implementation, since the achievement of one goal can impact the achievement of other goals, a target can be associated with three different cumulative stages: one for needs, one for needs and projects, and one for needs, projects and goals. Each stage can be associated with a given indicator threshold, where the threshold for “needs” is greater than the threshold for “needs and projects,” which is greater than the threshold for “needs, projects and dreams.” Then, if the indicators calculated for the “needs,” “needs and projects” and “needs, projects and dreams” are respectively above the first, second and third threshold, the overall indicator can be indicative of a positive outcome, i.e., that all goals are likely to be met. Otherwise, the indicator reported is indicative of a negative outcome, i.e., it is unlikely that all goals will be met. The method may thus comprise a step of associating, by the one or more processing devices, indicator thresholds with the different goal types. In this case, the indicator is expressed as a joint probability that all indicator thresholds will be met for the financial goals entries. For example, if the indicator for financial goals that are needs is 100%, the indicator for projects is 80% and the indicator for dreams is 75%, the joint probability can be calculated as a mean of all three indicators, and if weights for needs, projects and dreams are respectively 60, 30, 10, then the final indicator would be: 91.5%.

In yet other implementations, the weight associated with a life goal can be based on a degree of commitment associated with the life goal. The indicator can thus take into account the probability that the client will achieve a given goal. The degree of commitment to goal determination module 146 can be used to determine this probability using the gathered financial data 40, including spending and/or saving habits identified from this financial data. Additional data such as personal information data 94, socio-economic data 90, behavioural data 92 relating to the client can also be used to determine the degree of commitment the client has towards a goal. The degree of commitment can be determined by the one or more processing devices of the computer-implemented simulation system, based on the historical income data and historical expense data.

In possible implementations, the degree of commitment associated with the financial goals is performed using a trained machine learning model. The degree of commitment corresponds to a predicted probability outputted by the trained machine learning model that a specific financial goal will be achieved. Historical income data and historical expense data is inputted to the trained machine learning model, and the prediction or importance to assign to a goal is determined based in the historical data. Preferably, trained machine learning models can be used to predict the probability that the client (or related entities) will achieve the goals set. Two clients with identical financial wealth data, monthly income and spending and socio-economic data may have very different propensities to achieve particular life goals. For one, the goals may be a vague wish, or the client may have little discipline to save money to achieve the goal. For the other client, the goal may be a first priority and he will adjust his spending to achieve the goal. Financial data relating to spending habits can be used to predict the likelihood of achieving specific life goals. For each life goal, the “degree of commitment to goal determination module” 146 can collect or access existing client financial data, personal information data, socio-economic data and behavioural data and whether the client achieved or did not achieve the goal. The collected data can be labelled accordingly, and an AI model can be trained with this training data to predict the likelihood that a client will achieve the same goal. According to a possible implementation, different machine learning models can be trained for different life goals. In the example of FIG. 2, three trained AI-model (18, 18′, 18″) are shown, each having been trained and being able to predict the likelihood that a given client will be able to take a sabbatical year, will be able to retire early, or will be able to buy a house, but of course, there can be as many model as possible life goals that can be created in the system 10.

Still referring to FIG. 2, the system 10 can also generate customized or personalised financial products, for which parameters are calculated as a function of the client's financial goals entries and based on the financial projections and on the indicator calculated for the clients. The system 10 comprises a customized financial products module 15, which includes different sub-modules: a customized loan module 154, a customized life insurance module 156, a customized HELOC (Home Equity Line of Credit) module 158 and a customized real estate listing module 159. The customized financial products module 15 can create financial product offers, which are different that the standard products advertised by a financial institution. The customized financial product offers are generated such that cash flow projections for the individuals remain positive for their entire lifetime and/or such that the indicator of the likelihood that the individual will achieve their life goals stays above a predetermined threshold.

Referring to FIG. 2A, possible steps implemented by the customized financial products module 15 are shown in a high-level flow chart. Steps 260 and 270 follow steps 230 and 240 of FIG. 1, wherein the life goal indicator 70 and the cash flow and/or financial projections are calculated by modules 144 and 142. Based on this data, at step 280, the module 15 can identify whether there are one or more periods during which the net cash flow is negative, meaning that all life goals set for the client are considered (i.e. all liabilities associated with the respective life goals are computed in the cash flow projections), and that for some periods, there isn't enough cash to cover common living expenses and the needs, projects and/or dreams the client has set for himself. This process can also be used to identify potential negative cashflow periods according to different scenarios, such as a severe downturn in the market, the death of a spouse, or a job loss, as examples only.

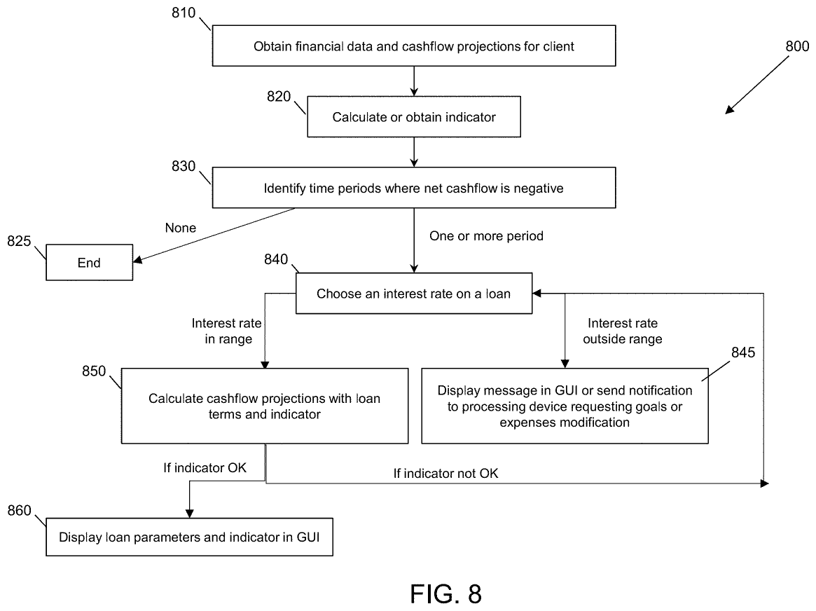

If negative cashflow periods are identified, the amount needed, and the duration of the period are also determined. In the example of FIG. 2, the loan module 154 can start by evaluating an initial loan of $8,500 at the standard advertised interest rate of 3.25%. If the indicator is still below a predetermined threshold, the module 154 can iteratively lower the loan interest rate, while validating that a set of financial constraints or rules (obtained from database 86) are still met (such as not lowering the rate below a floor rate), until the indicator reaches a given threshold (step 292). If a financial product can be identified such that it meets all financial constraints for said product (such as maximum amount, floor interest rate, maximal loan reimbursement period, etc.) and allows the individual's indicator to stay within a predetermined interval (such as between 70-90%), then the financial product offer can be displayed in the GUI 16, on an electronic device of the client or of another user, such as a financial advisor. Alternatively, a notification with the financial product offer can be sent, by SMS or email, for example. In possible implementations, the customized financial products module 15 can comprise a module that can schedule the offer for the financial products to be sent in a notification at a time sufficiently in advance of the period where the net cash flow is determined as negative. More details on possible implementations of this method and module are provided later in relation with FIGS. 8 to 12.

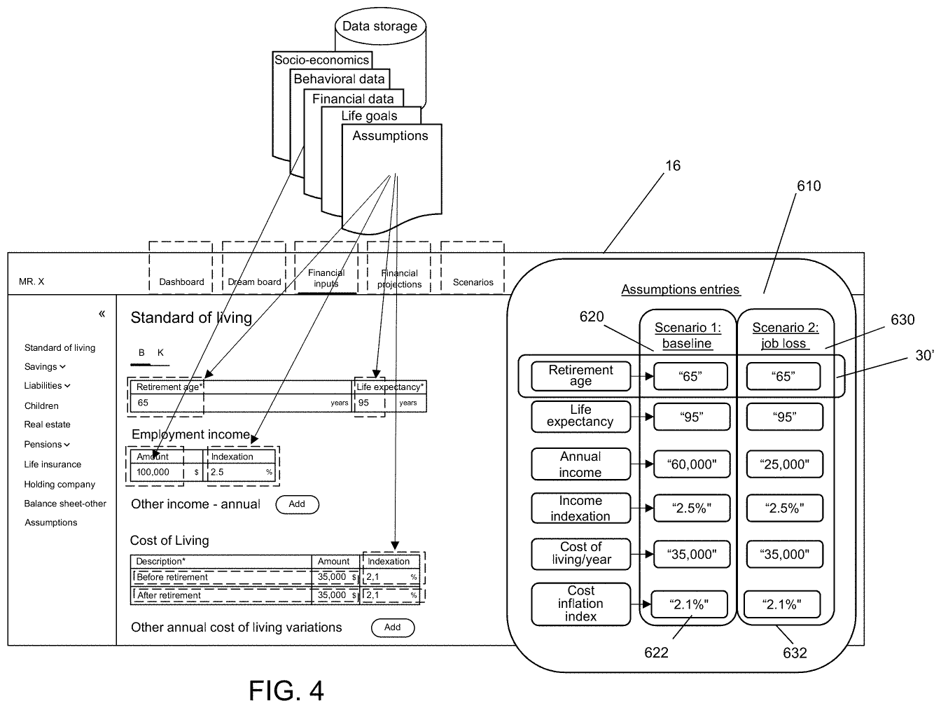

Referring to FIG. 3, the financial goals can be set for a given individual, or for a household. In other words, each partner or spouse can have their own financial goals, and financial goals can be set for the household as well. In FIG. 4, an exemplary list of assumption values 610 is illustrated. In possible implementations of the system, at least some of the assumptions can be fixed or predetermined, such as the cost-of-living index. However, preferably, the assumptions 610 are configurable via the GUI 16, wherein a user can input different assumptions values, such as the life expectancy, the retirement age, the employment income, the employment income indexation, the annual cost of living, etc.

Still referring to FIG. 4, end users can create different financial scenarios. For each scenario, a set of assumptions values can be entered. In the example, a first scenario can be created and named “scenario 1” or “baseline scenario”. Different assumptions values can be entered and stored, including assumptions relating to a life goal, such as the desired retirement year. A second scenario, named “scenario 2” or “job loss”, can also be created, according to which the employment income drops significantly, in order to assess, using the different tools of the system 10, the impact of a job loss for one partner of the household

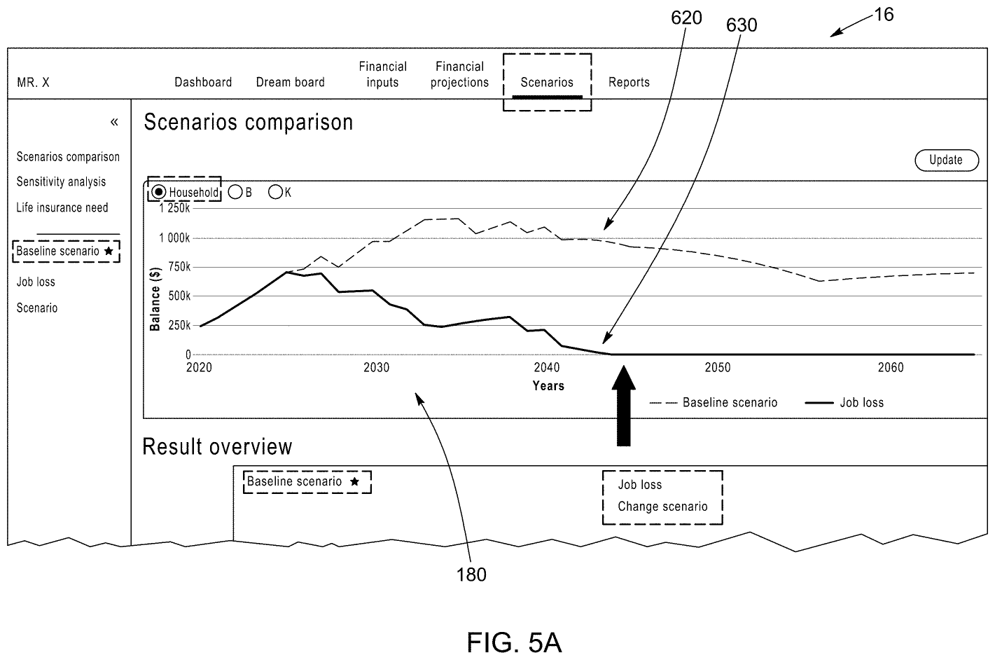

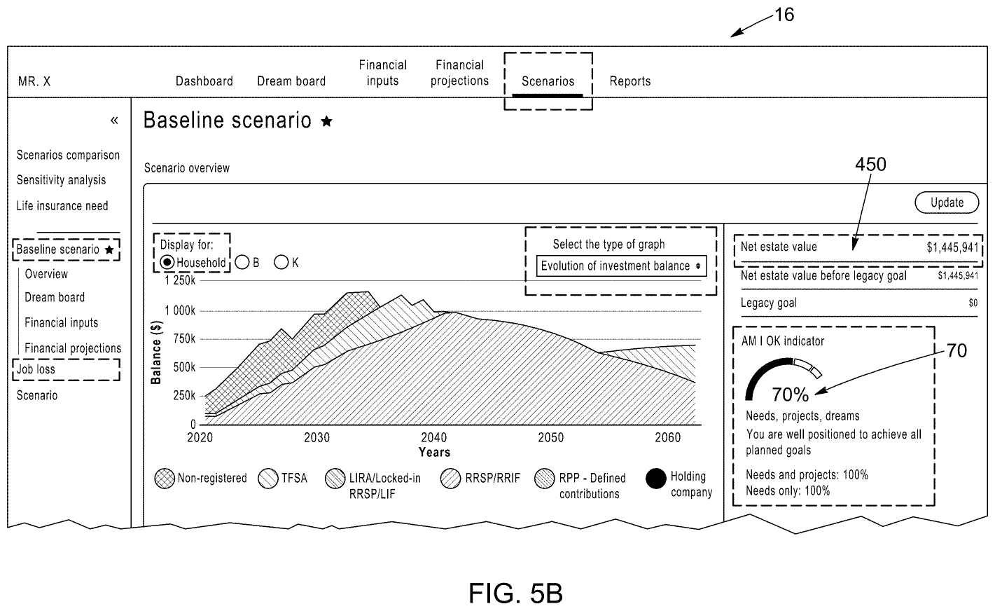

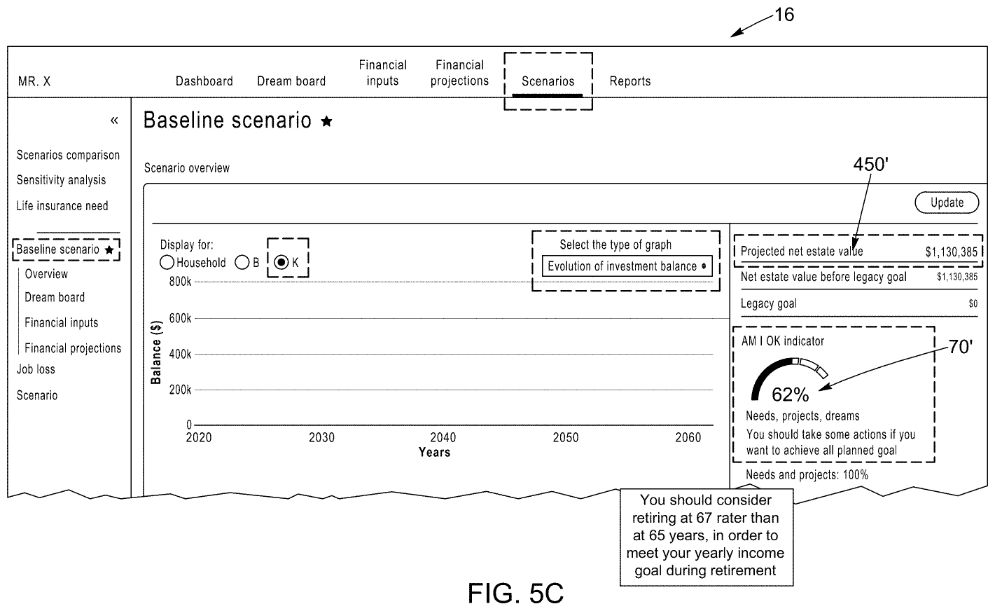

Referring to FIG. 5A, the proposed system can display in the GUI 16 the first scenario, as a financial projection, specifically of the net worth as a function of time. The first scenario 620 corresponds in this case to the baseline scenario. A selection of a second scenario 630, in this case the “job loss” scenario is also captured in the GUI. As schematically illustrated in FIG. 4, the second scenario comprises a change in one or more of the life goals' time parameters and/or financial parameter, or a change in at least one of the assumption values of the first scenario. In the example, the change in one of the assumptions corresponds to a variation of the income revenues, from $60,000 to $25,000. The calculation module 14 automatically re-simulates the cashflow and financial projections, according to the second scenario. The GUI displays the first scenario and the second scenario in the same window, allowing to better visualize the differences between the two scenarios. Preferably, the indicator is updated, indicating the impact of the second scenario on the likelihood of achieving the goal(s) of the client or household, thereby showing how variations in financial projections affect the likelihood of achieving one or more life goals set by the individual. The GUI shows the values of the financial projection over time, for both scenarios, simultaneously.

The initial set of assumption values can be stored and associated with a first scenario. Initially, the financial planning application of the remote device displays in the graphical user interface of the user's remote device, a graph representative of the combined financial projections simulated and associated with the first scenario. The financial planning application of the remote device then captures, via the graphical user interface, a selection of a second scenario. The second scenario will comprise a change one or more of the assumption values associated with the first scenario. The financial planning application of the remote device then sends to the computer-implemented simulation system an updated electronic request, for updated financial projection data and for an updated indicator. Upon receiving the updated electronic request, the computer-implemented simulation system automatically re-simulates a plurality of financial projections, also by applying each time a different variation. The indicator is updated accordingly. The communication interface 140 of the computer-implemented simulation system then sends the updated indicator and the updated financial projection data to the financial planning application of the remote device. The financial planning application of the remote device can thus display, in the graphical user interface, the graph of the first scenario and a graph of the second scenario, as well as the updated indicator, indicating the effect of the second scenario on the likelihood of achieving the financial goals.

The GUI allows for different changes to be made to the life goals themselves (such as by adding, changing or removing goals). The changes can also be made in the assumption values or parameters associated with a goal. As examples only, such changes can be applied to: an investment return rate used for one of the scenarios; a risk profile associated with the individual; a retirement date and a life expectancy.

In possible implementations, as shown in FIGS. 5B and 5C, a value of the estate at death may be displayed as a single number, as indicated by box 450. The indicator 70 is also displayed to indicate how likely it is that the client will achieve his/her goals. The GUI can include a pull-down menu or a box to change an assumption or one of the goals and have the financial projections recalculated automatically and displayed on the screen, including the updated net estate value 450′ and updated indicator 70′. For example, a user may change the retirement age from 65 to 62 or simulate a job loss.

Still referring to FIG. 5A, the GUI comprises means to select one or more entities associated with the individual, including: the individual itself, other individuals such as spouses, children or partners. The GUI can also allow to select other types of entities related to the client, such as trusts and companies. For example, the client may own a company that generates income, expenses, and debt and has associated financial data. The system 10, and more specifically the financial projection and indicator calculation module, is configured and adapted to combine the financial data from different entities (such as individuals and companies) and graphically show the combined result in the GUI or to allow the user to select only one of the entities and show the result in the GUI for that individual only. The combined result may include cashflow projection, financial projection, or indicator, or any combination of the three. These could be displayed for a given time or as a function of time, for instance by year.

More specifically, the GUI comprises means to capture a selection of the one or more entities from the graphical user interface. In response, the calculation module 14 calculates the first and/or the second scenarios of cash flow or financial projections for the entities captured, based on their respective financial data. The first and second scenarios for the selected entities can then be displayed on the graphical user interface. In the example of FIG. 5A, the GUI 16 displays in the graph 180 the results from combining the values of the different accounts of the individuals in the household (in this example two individuals), at a given point in time or over a given time period. In FIG. 5C, the baseline scenario for only one of the two partners of the household (in this example, K) is calculated and displayed.

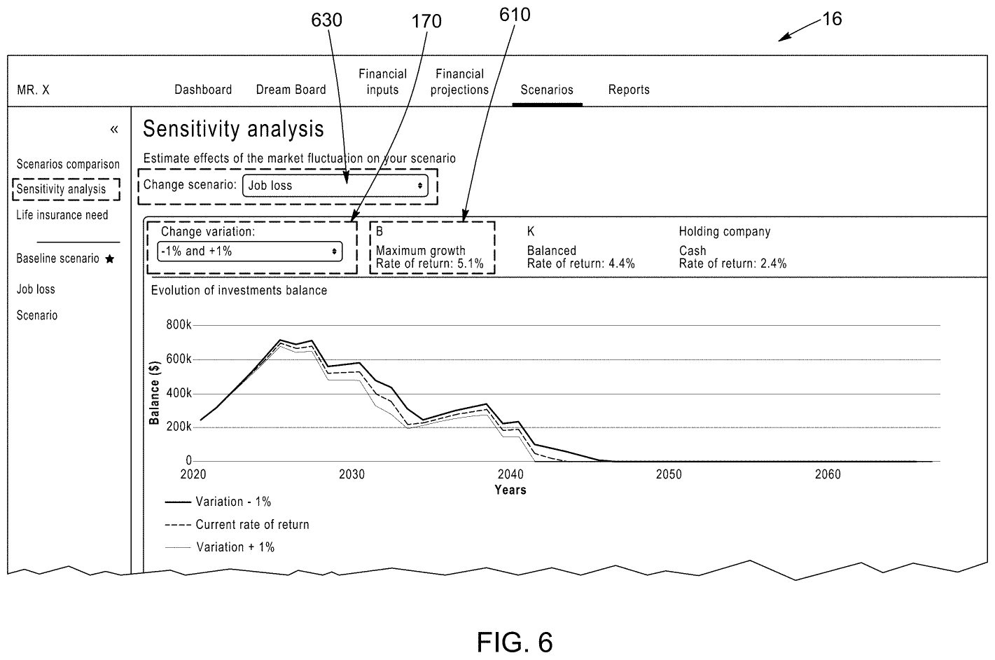

In possible implementations, the proposed system can also be configured and adapted to calculate, for each client or for his household, the annual net wealth of the client or household based on assumptions and projected cashflows. The calculation module 14 can identify the year in which net wealth goes to zero (i.e., the client has run out of money before death). FIG. 6 shows a possible way of indicating the year at which the net wealth goes to zero, as an assumption value is varied. The financial projections simulated can comprise cash flow projections and/or a balance or net worth projections. The net balance corresponds to a value of the estate at an assumed year of death of the individual.

The GUI could also comprise means to vary the assumption “monthly retirement expenses” by an amount (such as decrease by 10%), while keeping all other assumptions unchanged (investment returns, current monthly spending, incomes, etc.). The calculation module 14 would recalculate the annual net wealth of the client as a function of time and identify the year in which the net wealth goes to zero. This process can be repeated, either automatically or manually, for multiple variations in the monthly retirement expenses (such as +/−15%, 10%, 5%) and the GUI can display, for the client or the advisor, the year when net wealth goes to zero (y-axis) vs monthly retirement expense (x axis). To determine the year at which the net wealth goes to zero, different alternatives can be considered. According to a first alternative, the calculations can be performed using a deterministic model, in which all assumptions are taken at their initial value, except for the one that is varying (e.g. monthly retirement expense). According to another alternative, the Monte Carlo method can be applied, by changing the initial assumption value for monthly retirement expense to a new assumed value and by taking an average of years when the net wealth goes to zero. Yet according to another alternative, the GUI can show a range of years when the net wealth goes to zero, for each value of monthly retirement expense.

Alternatively, the GUI can show the data in column format. The system can therefore help clients understand the effect of variations in assumptions relating to retirement spending on their net wealth. For example, the GUI can be configured to display the first year in which the value of the net worth decreases from positive to negative, and the second year in which the value of the net worth decreases from positive to negative, given a variation on an assumption value relating to retirement expenses. The variations can be displayed in a graph or as a set of values.

Referring to FIG. 2, and also to FIGS. 5B and 5C, in possible implementations, the calculation module 14 is configured to periodically recalculate the financial projection(s) and the indicator. The recalculations can be performed according to a given one of the scenarios captured through the graphical user interface, using the most recent assumptions and/or financial data available for the individual. When the indicator falls below a predetermined threshold, an “alert or notification module” 148 can inform the client (or user—such as a financial advisor) that the life goals set for himself are unlikely to be achieved, unless changes occur in the spending or saving habits of the clients. In other words, if the indicator value is no longer in the acceptable range for a particular client, the financial planning application module 150 can identify the life events and goals that are nearest in the future and determine an advice related to those life events and goals that will enable the client to more likely achieve them. For example, a client who wishes to retire in 5 years and whose investment portfolio suffers a significant loss will have new advice identified for him, such as reducing current expenses and saving more and considering delaying his retirement date.

The calculation module 144 and/or and the finance planning module 150 can thus be configured and adapted to determine the changes in one or more of the assumptions that are needed to help the client realign his habits to increase the likelihood of achieving his goals. The module 14 can determine a variation in the time or the financial parameters of the goal(s) and/or in the income data and/or the expense data, that will increase the likelihood of achieving the initial or modified life goals. For example, if the interest rate of a loan has increased, and the client has set a goal of reimbursing the loan within a given number of years, the modules 144 and 150 can determine the extra amount needed each month to make sure the reimbursement goal is met. The alter/notification module 148 can send the financial advice (such as “increase monthly payments) to the client or to the clients' financial advisor via an electronic communication.

In possible implementations, the one or more processing devices determine, for years of the time interval during which the net balance is negative, a modification to the time or the financial values of the financial goal entries, the projected incomes or the projection expenses, that will increase a value of the indicator. A financial advice can be generated by the finance planning module 150, based on the modification determined. An electronic notification comprising the financial advice can be sent to the user's remote device via the alert/notification module 148. The generation of the financial advice can comprise automatically determining a loan amount and interest rate that allow the simulated financial projections to remain positive for all years of the simulation period.

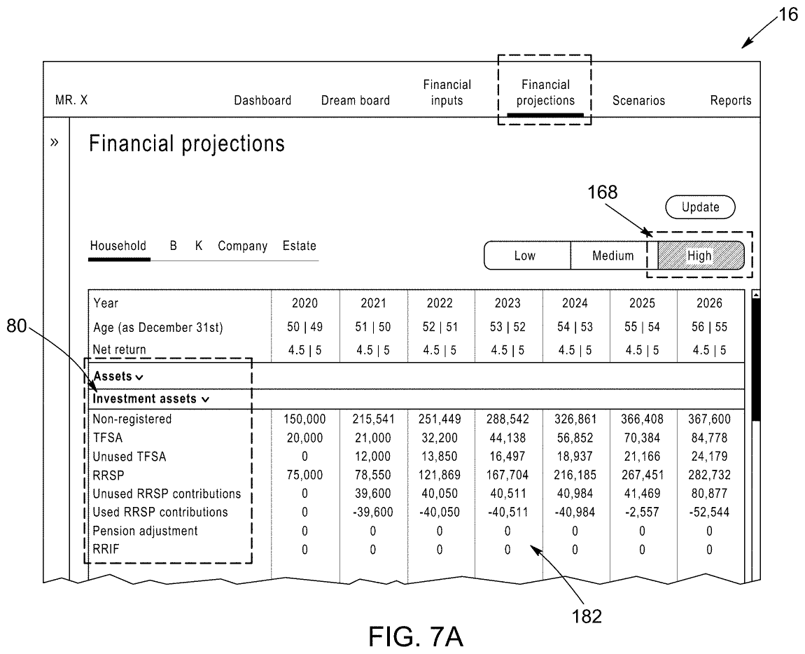

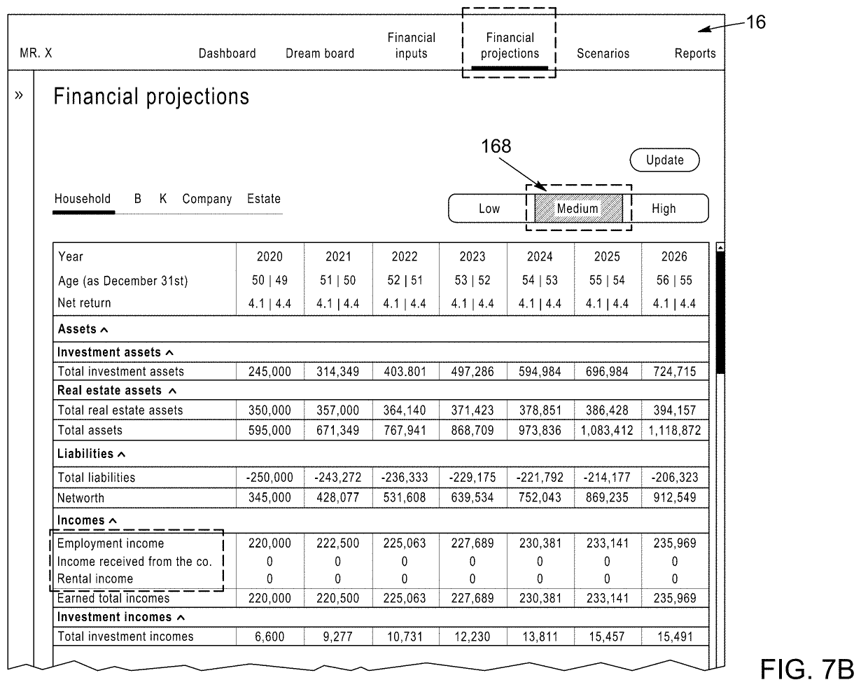

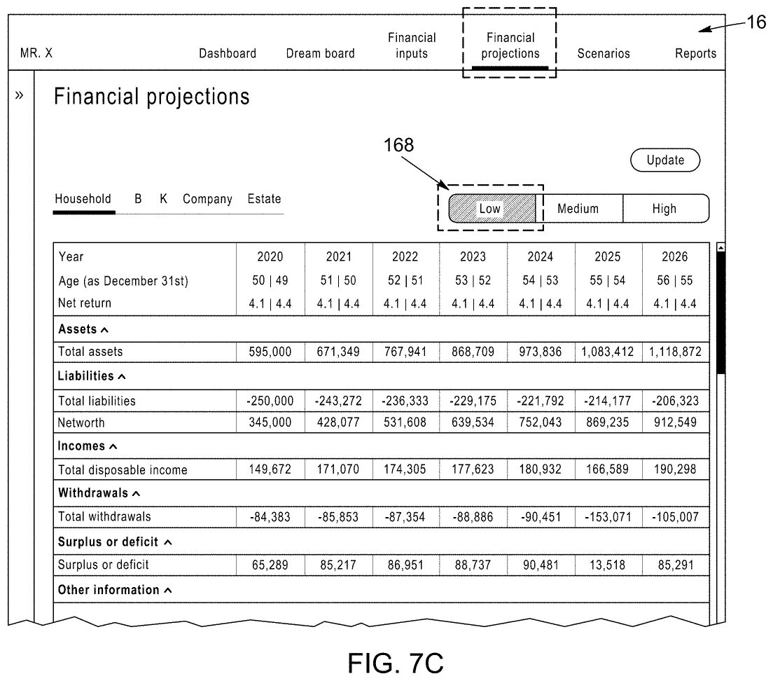

Referring to FIG. 5A, the GUI 16 comprises a graph 180 having a first axis for time and a second axis for dollars, and wherein the first scenario and the second scenario are superimposed on the graph. In order to better visualize and distinguish the first and second scenarios 620, 630, each is displayed in different colors and/or line format. In other possible embodiments, as shown in FIGS. 7A to 7B, the GUI 16 may also comprise tables 182 or sets of financial and time values. In possible embodiments, tables or sets of data can each be associated with one of the first and second scenarios. Side by side tables or sets of financial and time values allow a comparison of the first and second scenarios in the same window of the GUI. As there are many variables in the calculation of cashflows and balance projections, it is inherently very difficult to show how changes in multiple assumptions may affect cashflow or balance. The proposed system allows to show visually the effect of changes in some of these assumptions will have on financial projections.

Referring now to FIG. 6, a variation interval 170 can be applied on an assumption value 610 associated with the first or second scenarios, through the GUI 16. The variation interval 170 comprises a lower bound and an upper bound. The GUI can then simultaneously display the effect of the variation interval 170 on the scenario for which the variation has been captured, while still displaying the initial scenario. The system thus recalculates the financial projection of a given scenario, using the upper and lower bounds on the selected assumption value, and the GUI displays on a graph the effect of the variation. The financial planning application of the remote device, via the graphical user interface, captures the variation interval 170 to use when applying the variations on the set of assumptions values. The lower bound and the upper bound determine the scope of the variations to apply when simulating the financial projections, such as between −1% to +1%. The effect of the variation interval can be simultaneously displayed in the graphs of the first or second scenarios for which the variation interval has been captured, while still displaying the initial first and second scenarios.

As can be appreciated, the system is configured and adapted to allow users to visualize the effect of small changes in an assumption. For example, the user may select the return rate on investments, and the GUI can display the net wealth as a function of time superimposed on a plot for 1) the assumed investment return rate, 2) the same rate minus 1% and 3) the same rate plus 1%. In FIG. 6, the three graphs are displayed in different colours on the same plot (e.g. green for assumed rate, blue for rate −1% and red for rate +1%). Alternatively, the curves can be displayed with different dashes, dots and full lines. In addition, a selection menu enables the client to change scenarios and perform the same sensitivity analysis on a different scenario. The new scenario may involve different goals and life events (for instance, one scenario includes purchasing a cottage at age 60 and another does not) or may involve different assumptions (for instance a different retirement age).

Referring now to FIGS. 7A, 7B and 7C, the graphical user interface shows financial projections for a client and comprises means 168 to select a level of detail of the financial projection data being displayed. The GUI is configured to display the first or second scenarios according to the level of detail captured. In the exemplary interface presented, three different levels of detail are available, but a different number of levels can be considered. As shown in FIG. 7C, one level is a low-level of detail, wherein the GUI is configured to display the assets and the liabilities, the incomes and withdrawals and the surplus or deficit of the net worth. FIG. 7A shows the GUI when a high-level of detail has been selected: in this case, the GUI is configured to display all sources of financial data 80, used to calculate the surplus or deficit of the client's net worth. FIG. 6B shows a medium level of detail.

Most users may wish to see a limited amount of information in the form of numbers, such as income, spending and surplus or deficits for each year (e.g., 3 numbers per year). Other users may wish to see in addition the sources of income (employment, retirement, government benefits, etc.) per year and the value of investments (e.g., 5 or more numbers per year). Finally, a third group of clients may wish to see all the data, including income streams, different types of spending, taxes, the value of assets and liabilities, surpluses and deficits.

The GUI comprises means (in the example: different icons) enabling users to select the level of detail he/she wishes to see. For example, selecting “low” will show a limited number of lines of data, “medium” will show more lines of data and “high” will show all the data. When the choice is made, the GUI module generator 152 (identified in FIG. 2) sends instructions to the GUI to display the appropriate numbers on the GUI. This feature enables users to see less or more information depending on their preferences.

Referring now to FIG. 8, financial institutions currently offer loans where the interest rate on the loan is based on the cost of funds and a premium related to the client's credit score. Under some circumstances, the premium may also be related to the number of other products the client has with the financial institution.

According to the method and system presented in FIGS. 1 to 7, the cash flows and financial projections calculated provide a better understanding of the evolution of the financial health of a financial institution's clients over their lifetime. The customized financial module 15 can use this information as input data to identify and/or generate customized financial offer(s), such as custom loans or life insurance products, that fit their financial circumstances and allow the clients to achieve goals that they are unlikely to achieve otherwise. For example, it may be that the standard loan offers by the financial institution have uncompetitive interest rates, such that a client can find loans with a lower interest rate elsewhere. A standard loan offer may also be inadequate for being based on a credit score that is out of date. The cash flows and financial projections calculated in the previous steps can be used as input data to allow the system 10 to generate a load offer at a competitive interest rate and retain the client's business.

Another benefit for the client is that if they have goals that may initially appeared to be unattainable, meaning that their indicator value is below a predetermined threshold. Taking a loan and repaying it in the future may enable them to achieve that goal at a cost that is acceptable to them. For example, if the cash flow projection for a given client comprises a 5-year period where the cashflow is negative by an amount of $10,000 per year, which brings the indicator value below an acceptable threshold, a loan at an interest rate that enables repayment of the loan from year 6 to year 10, when the incomes of the client are projected to increase, can be offered to the client. If the assets of the client are sufficient, and the financial constraints set by the financial institution are met, a loan offer can be automatically generated by the module 154. Otherwise, without the loan, a client may be forced to modify or eliminate a goal that caused the negative cashflow.

Referring still to FIG. 8, the method 800 of generating a customized loan offer will be explained. At step 810, the client's life events and goals and associated cash flows and financial projections are obtained at step 810. At step 820, the indicator of the likelihood that the client will have enough money for his life events and goals, according to a given scenario, is calculated or obtained. Modules 144 and 142 (identified in FIG. 2) can provide the cash flow projection, financial data and initial indicator.

At step 830, the customized loan module 154 verifies, using pre-set thresholds and a comparison function, whether the indicator is within an acceptable range, such as between 70 and 90%. In addition, the module 154 parses the cash flow projection for each month or year of the timeline, to identify time periods where the net cash flow is negative, since a negative cashflow period is indicative that a loan or a withdrawal may be needed. If the indicator value is within the acceptable range and there is no negative net cashflow period, the method ends at step 825.

If a period with a negative net cashflow has been identified, a loan offer can be generated, according to steps 840 to 870. This process starts by generating an initial loan for the amount that would bring the cash flow positive during the period, at an initial interest rate IRᵢₙᵢₜ for the loan. The initial interest rate can correspond to a posted interest rate offered by the financial institution, which we can obtain from the data source or database 86 (identified in FIGS. 1 and 2.) The loan and the subsequent loan repayments can be incorporated into revised cash flow projection calculations, and a new/revised indicator value is computed at step 850. If the indicator value is within the acceptable range, the loan amount and the initial interest rate can be displayed and proposed as a loan product at step 860. If the indicator value is not within the window (e.g. lower than 70%), then the process is repeated, back at step 840, wherein a new lower interest rate IRᵣₑᵥ is selected (for example, by reducing the initial IR of 0.10%) for the next iteration. At step 850, the cash flow projection is recalculated with the loan amount and the new repayment schedule, and the indicator value is also recalculated. This sub-process is repeated until the interest rate IRᵣₑᵥ selected brings the cash flow projection positive and indicator value in an acceptable range (e.g. greater than 70% respectively).

Business rules or financial constraints can be set on the interest rates selected during the iterative process. These constraints can comprise a floor interest rate corresponding to the cost of money of the financial institution, plus a given profit margin (retrieved from database 86), plus a client-specific value. The client-specific value can be related to a parameter of the client's profile, such as the credit rating, the past credit behaviour, the assets and debts (obtainable from database 82 and 84). If the chosen interest rate at step 840 is outside the acceptable range, the method proceeds to step 845 where a notice is displayed or sent, suggesting a modification of the life goals, such as eliminating a goal or reducing its cost. The changes can be saved in database 80, such that the cashflow projections are no longer negative and the indicator is within the acceptable range.

If multiple periods of negative cash flow are identified in the cashflow projections, a distinct loan can be generated for each period, adding the loan amounts and repayments from the previous period(s) of negative net cash flows to the calculation of cash flows for the next period of negative cash flow projections.

According to another aspect, clients with substantial assets may face a sudden downturn in the market near retirement. They may then be forced to sell assets at a substantial lost to fund short term needs, putting their future retirement plans and goals at risk.

To prevent this situation, module 158 can identify clients within N years of retirement, where N can be a given number of years from retirement, such as between 3 and 10 years. This identification process can be run periodically, for all clients of a financial institution. From said list of clients, module 158 can identify clients owning a real estate property with substantial capital built up in the property. Module 158 can then calculate or obtain the client's projected cashflow and financials. The client's indicator can be calculated by simulating a X percent drop in the market (applied for example on all assets held in the client's portfolios). The simulation can be performed by calculating the indicator using a negative return on the client's investments vs the expected return. If the indicator falls below a predetermined threshold, module 158 can calculate the amount needed to be added to the client's assets at the time of the market drop in order to bring the client back to the indicator acceptable range. Once this amount is determined, the module 159 can generate a House Equity Line of Credit (HELOC) offer corresponding to the amount needed or more.

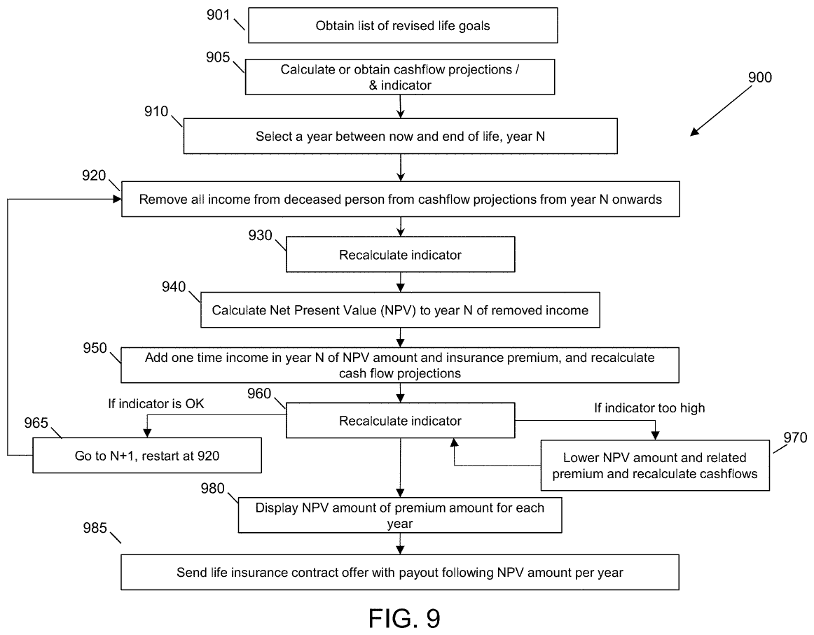

Referring now to FIG. 9, another possible implementation of the customized financial product generation method will be described. Life insurance is generally regarded as a replacement of future income in case of death. As such, a person's needs for life insurance are usually highest when they are relatively young and face expenses for a number of years, such as when they first have a family and/or buy a house. As they age and approach retirement (when work income disappears), their need for life insurance decreases. However, most life insurance policies offer a fixed payout (known as the life insurance need) over the period of the contract (for example, 20 years for term insurance, or until death for perpetual life insurance). Thus, the client may be under insured at the earlier stages of the insurance contract and over insured towards the end of the contract. In most cases, the life insurance needs are determined through simple rules, such as X amount for a given age or family situation or based on the cost.

Disadvantageously, this approach does not consider general living expenses, investments, or life goals in determining the amount of life insurance needed. The proposed method 900 enables a more targeted assessment of the amount of life insurance a client needs, considering their life goals and projected cashflows.

FIG. 9 shows a possible implementation of a method 900 for generating a customized insurance product. Preferably, the method 900 involves calculating the need for life insurance based in part on the importance (or the class/category) of the life goals, for example based on whether a life goal is a need, a project or a dream. Broadly, the method comprises calculating projected cashflow of a household based on the respective life goals of the household's members, calculating the need for life insurance for each member and generating a life insurance offer for each member, where the need for life insurance of each member is weighted by the classes and/or costs of the life goals. By “weighted”, it is meant that life goals classified as “need” will require their specific indicator to reach a higher threshold than a life goal classified as a “project” or “dream”.

The first step of the method, step 901, comprises retrieving or obtaining a list of revised life goals, for the second spouse (or second client), assuming the first spouse (or client) is the insured party. Given that the life goals that a couple may have agreed upon are likely to change if one of the spouses passes away, a list of revised life goals set of the second partner can be retrieved, assuming the first spouse passes away first. In a similar manner a revised list can be retrieved for the first partner assuming the second spouse passes away first. For example, the second spouse may no longer want a vacation home in the south if she loses her partner or the first spouse may not want to buy a new sports car if she loses her partner. As such, in a preferred implementation of the method, a revised list of life goals is used for each partner, the revised list being determined assuming one of the spouses has passed away. This list of revised life goals for each spouse can be stored in database 80. Step 901 is optional, and the proposed method can also be performed with the “standard” or “default” list of life goals of the spouses.

At step 905, the customized life insurance module 156 (identified in FIG. 2) retrieves or calculates, based on data from the data sources 80, 82, 84 (also identified in FIG. 2), the cash flow projection and the indicator value for the household. The cash flow projections and indicator can also be obtained from modules 144 and 142 (also identified in FIG. 2). At step 910, the assumed year of death of the first spouse is set to a year N, between the present year and the assumed year of death of the second spouse. At step 920, the module removes all incomes from the deceased person (i.e. first spouse) from the cash flow projections from year N+1 to the end of life year of the second spouse. The module then calculates the indicator at step 930. Presumably, the indicator decreases substantially. In step 940, the module calculates the net present value (NPV) from year N+1 onwards of the removed income. At step 950, the module adds a one-time income in year N+1, equal to the NPV amount calculated at step 940, and adds the insurance premiums payable from year N until year end, to the cash flows as expenses. The module then recalculates the cash flows. In step 960, the module recalculates the indicator which should increase. If the indicator is too high, such as above 90%, the module will iteratively lower the NPV amount and the related premiums and will recalculate the cash flows (step 970) as well as the indicator (step 960). This subroutine (steps 960, 970) is iteratively performed until the indicator is within a predetermined range (such as between 70% and 90%). If the indicator value is within the acceptable range, steps 920 to 960 are repeated for each following year, from year N+2 to the end of life of the second spouse. At the end of the process, the module has determined the NPV which represents the minimum life insurance payout needed that is optimised for each year from year N until the year of the end of life of the second spouse. The module 156 can (via GUI generator module 152) display the minimum life insurance pay-out in a graph or in a table on GUI 16. In step 980, the module can automatically generate a life insurance contract with a pay-out that follows the changing NPV amount over the years, between now and the year of death. As can be appreciated, the proposed method allows modulating the life insurance pay-out of an insured party, according to their specific financial data and life goals.

Still referring to FIG. 9, the same method can be repeated, according to a scenario where the second spouse is the insured party. The advantage of the present method is that if the first and second spouses have different incomes, the NPV amounts will differ for each individual. The module 156 allows generating, for each spouse, a different graph of NPV amount per year. The module 156 can automatically generate distinct life insurance contracts for each partner, that will have different net present values (NPV), i.e. different life insurance pay-outs.

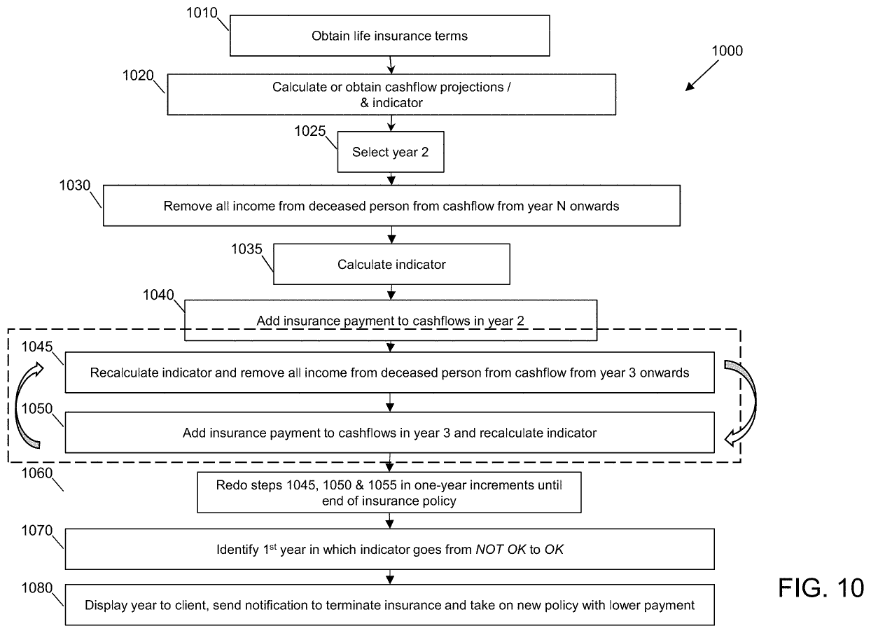

Referring now to FIG. 10, another process 1000 relating to the automatic generation of customized life insurance offers, based on a client's financial data and life goals, is illustrated as a flow chart. This process can also be performed by the customized life insurance module 156. Broadly, the objective is to identify, based on life goals and client specific financials, the year in which the client's life insurance pay-out is larger than needed, and to send a notice or display the information for the client or his/her advisor. In other words, method 1000 calculates cash flow projections and the indicator, and determines when the client is likely to be self-funded by his own investments. The module 156 can generate notification advising the client to terminate his life insurance contract, as needs are covered.

According to one possible implementation, in step 1010, the module 156 retrieves or obtains from database 82 the terms (such as duration, pay-out option, premiums, etc.) of the life insurance contract of a client. In step 1020, the module calculates or retrieves the cash flows and the indicator value for the client, based on his financial data and life goals, via modules 142 and 144. In step 1025, module 156 can set the initial year to start the calculations at year Y=current year+1. In step 1030, the module removes all incomes for the deceased person from the cash flows from year Y onwards. In step 435, the module calculates the new value of the indicator, which has presumably decreased. In step 440, the module adds the insurance pay-out based on the insurance contract terms, to the cash flows in year 2. In step 1045, the indicator is recalculated. In step 1040, all incomes from the deceased person are removed from the cash flows, from year 3 (current year+2) onwards. In step 1050, the insurance payment is added (based on insurance contract terms) to the cash flows in year 3. In step 1055, the indicator is recalculated. At 1060, steps 1045 and 1050 are repeated in one-year increments until the end of the life insurance contract. In step 1070, the module identifies the first year (Yi) in which the indicator goes from “not okay” to “okay”, i.e. reaches a given predetermined threshold, such as 70%. If the life insurance payout is high enough, it may be that the indicator is always “okay”. In step 1080, the module can display, in the GUI, the year Yi which corresponds to the year the individual may be over insured and may be able to decrease the value of his life insurance contract. An electronic notification can be issued to advise the client to terminate the insurance contract in that year and/or to take on a new insurance contract with a lower payment.

According to yet another aspect, a method for identifying when a client is self-funded from investment returns and no longer needs life insurance is proposed, so as to generate a life insurance contract that has a customized termination date. People tend to be over insured towards the end of their working life. Their insurance pay-out has remained constant but their remaining work years and future income is decreasing to zero. If they have invested during their working life, they may have sufficient assets to no longer need any life insurance and could therefore save the cost of the premiums.

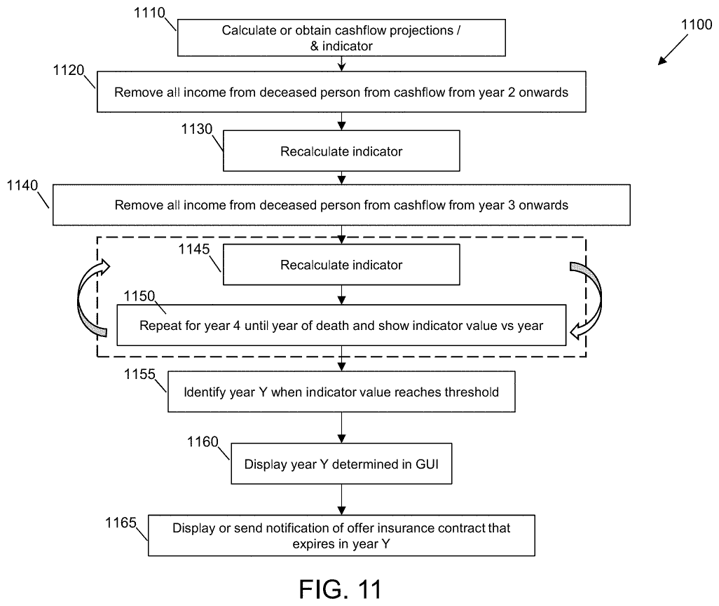

Referring to FIG. 11, a method 1100 for identifying the year for which a client's indicator is in an acceptable range and for which the client no longer requires insurance payment income is illustrated as a flow chart, according to one possible implementation. In step 1110, the module 156 can obtain or calculate the cash flows and the indicator value, based on the financial information associated with the client, stored in database 82 and/or via modules 142 and 144 (identified in FIG. 2.) In step 1120, the module 156 removes from the cash flow projection all incomes from the deceased person in year 2 onwards. In step 1130, the indicator is recalculated. In step 1140, all incomes from the cash flows from the deceased person in year 3 onwards are removed, and the indicator is recalculated in step 1145. In step 1150, the process is repeated for year 4 until the assumed year of death. A different indicator value is thus associated with each year. The module identifies the year when the indicator value reaches a certain threshold (for example greater than 70%) in step 1155, and can then display, on the GUI, the indicator values as a function of years, as per step 1160 and the year in which the indicator value reached the threshold. In step 1165, the module 156 can generate or update the terms of an insurance contract, such that it expires in the year identified at step 1155.

According to another aspect, the proposed system and method can assist clients in identifying real estate properties that the client can afford while maintaining his indicator above a given threshold. Taking into consideration the client's cash flow projection, the customized real estate module 159 assist clients interested in buying an investment property by obtaining real estate data, including for example listing of revenue properties, that the client could potentially buy while still maintaining his/her cash flow positive and the indicator within target levels. The real estate data can include information such as: the address, the price, the number of apartments, the city, the neighborhood, the date of construction, whether the apartments are occupied or not, the age of occupants, building declaration by the owner, etc.

Many clients have investment properties to generate income and capital gain. Some have multiple properties. Different types of properties (apartments, houses, duplexes) and different locations (downtown, off downtown, suburbs, vacation homes, cottages) generate different returns and expenses. The appropriate investment property for a client will depend in part on his current financial situation, including his existing investments (in real estate or otherwise). Some client's investment properties do not provide appropriate diversification or lead them to taking on too much debt or obligations that their cashflow cannot meet.

In order to better guide clients in buying real estate properties that suit their financial reality, without jeopardizing their life goals, the customized real estate listing module 159 calculates the cashflow projection by incorporating the expenses and incomes associated with the purchase of one or more real estate properties into the client's cashflows and verifies its effect on indicator value. In preferred implementations, the module compares two or more real estate properties to identify the one that provides the highest indicator value, while respecting other constraints, such as geographic location.

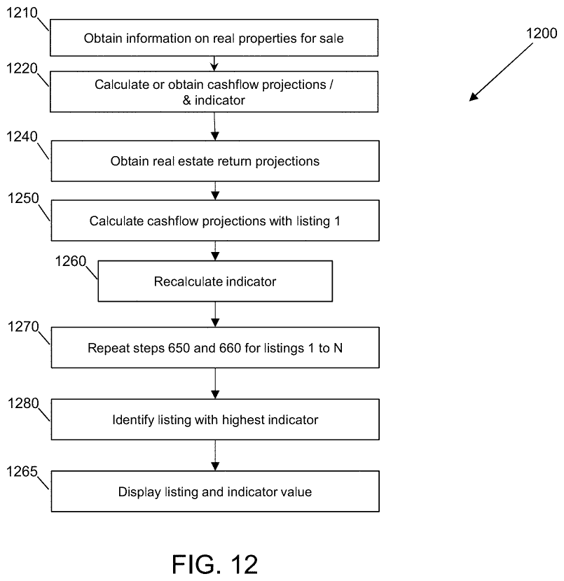

Referring to FIG. 12, in step 1210, the customized real estate listing module 159 obtains or retrieves real estate property information about a set of N real estate properties available for sale, including for example the purchase price, the estimated annual maintenance costs, the rental income, the location and the building type from database 88 (identified in FIG. 2). In step 1220, module 159 obtains or retrieves the cash flow projections and other financial data associated with the client from database 82 and/or from the financial and projection calculation module and indicator module 144. The customized real estate listing module 159 also obtains the client's indicator value from the indicator calculation module 142, at step 1230. In step 1240, module 159 obtains or retrieves an initial set of real estate listings that are potential investment for the client, based on the financial information of this client (such as available down payment and mortgage that the client can afford), and based on other information, such as the client's location for example. Module 159 also obtains or requests, from database 88, projected returns and standard deviations for real estate properties that are in a similar location or building type than the initial set of real estate properties located.

In step 1250, the cashflow projections are recalculated for the client, by including a first available real estate property of the initial set, assuming a return and standard deviation from step 1240 that is associated with the building type or location of the available real estate property. The indicator is calculated at step 1260, and the process is repeated for each real estate properties of the initial set, i.e. for property 2 to N. (step 1270). Module 159 can then identify the one or more real estate listings providing the client with the highest indicator value(s) at step 1280. The one or more listings that would allow the client to maintain his indicator within target can be displayed on the GUI 16 or a notification with the information can be sent electronically, alongside a representation of the indicator value (step 1280).

As can be appreciated, the various improvements described allows to better render and express the implications of assumptions and choices made when projecting financial information of clients. Providing an indicator, which is preferably be weighted according to the importance of each life goal set by an individual, helps grasp at first sight whether the financial planning for the client stands up. The different features described above, including especially the possibility of creating different scenarios and of displaying them simultaneously, and of appreciating the effect of small variations on assumptions of the scenarios, are also features that help clients (and their financial advisor) better understand their finance portfolio. The possibility of adapting financial products to the specific needs of a client, so that his/her life goals can be meet, also improves on traditional financial product offers.

The skilled reader will readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The embodiments are also intended to cover computers programmed to perform said steps of the above-described methods.

It should be appreciated by those skilled in the art that any block diagrams herein represent conceptual views of illustrative circuitry embodying the principles disclosed herein. Similarly, it will be appreciated that any flow charts and transmission diagrams, and the like, represent various processes which may be substantially represented in computer-readable medium and so executed by a computer or processor, whether or not such computer or processor is explicitly shown.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention could be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind.

### EXEMPLARY EMBODIMENTS

According to a possible implementation, a computer method for generating an indicator of the likelihood that an individual will achieve one or more life goals is provided. The life goals affect the finances or wealth of the individual. The method comprises: receiving the one or more life goals and life events associated with the individual, each comprising at least one of a time parameter and a financial parameter; gathering financial data associated with the individual, the financial data comprising income data and expense data associated with the individual or with entities relating to the individual; calculating a financial projection according to a given scenario, the given scenario being a function of the financial data gathered; and being a function of a set of assumption values that determines projected incomes and projected expenses; calculating the indicator of the likelihood that the individual will achieve the life goal(s) according to the given scenario, based on the financial projection calculated; and displaying the indicator on a graphical user interface.

According to a possible implementation, calculating the indicator is performed using a Monte Carlo simulation.

According to a possible implementation, each goal is associated with a respective weight Calculating the indicator can be a function of the different weights associated with the life goals.

According to a possible implementation, the life goals are associated with different types, based on their importance, the weight associated with a life goal that is classified as more important being higher than the weight associated with a goal that is classified as less important.

According to a possible implementation, one or more life goals include at least one of: retiring at a given time, purchasing assets or real estate property, paying for tuition fees, or taking a sabbatical leave.

According to a possible implementation, the weight associated with a goal is further based on a degree of commitment associated with said goal, the degree of commitment being determined using the gathered financial data, including spending and/or saving habits identified therefrom.

According to a possible implementation, determining the degree of commitment associated with a goal is performed using a trained machine learning model, the degree of commitment corresponding to a predicted probability outputted by the trained machine learning model that a specific goal will be achieved.

According to a possible implementation, different machine learning models are trained for different life goals, the machine learning models being provided with the gathered financial data and at least one of: personal information data, socio-economic data and behavioral data, to determine the respective predicted probability associated with the one or more life goals.

According to a possible implementation, the given scenario is a first scenario, the method further comprising: displaying in the graphical user interface the first scenario of the financial projection; receiving from the graphical user interface a selection of a second scenario, the second scenario comprising a change in one or more of the life goals' time parameter and/or financial parameter, or a change in at least one of the assumption values of the first scenario; automatically recalculating the financial projection according to the second scenario and updating the indicator; and displaying the first scenario and the second scenario in the graphical user interface, as well as the updated indicator indicating the effect of the second scenario on the likelihood of achieving the goal(s), thereby showing how variations in financial projections affect the likelihood of achieving one or more life goals set by the individual.

According to a possible implementation, the change in one or more of the life goals' time parameter and/or financial parameter, or the change in at least one of the assumption values of the first scenario comprises changing at least one of: an investment return rate used for one of the scenarios; a risk profile associated with the individual; a retirement date and a life expectancy; the graphical user interface showing the value of the financial projection over time for the first or second scenario.

According to a possible implementation, the graphical user interface comprises a graph having a first axis for time and a second axis for dollars, and wherein the first scenario and the second scenario are superimposed on the graph.

According to a possible implementation, the graphical user interface comprises two tables or sets of financial and time values, each associated with one of the first and second scenarios, the tables or sets of financial and time values allowing a comparison of the first and second scenarios in the same window of the graphical user interface.

According to a possible implementation, the first and second scenarios are each displayed in different colors and/or line format.

According to a possible implementation, the method comprises capturing a variation interval to be applied on an assumption value associated with the first or second scenarios through the graphical user interface, the variation interval comprising a lower bound and an upper bound, and simultaneously displaying on the graphical user interface, the effect of the variation interval on the scenario for which the variation has been captured, while still displaying the initial first and second scenarios.

According to a possible implementation, the method comprises recalculating the financial projection using the upper and lower bounds on the assumption value.

According to a possible implementation, the graphical user interface comprises means to select a level of detail of the financial projection data displayed, the method comprising: capturing a level of detail selected from a list of two or more detail levels, through the graphical user interface and; displaying the first and second scenarios according to the level of detail captured.

According to a possible implementation, the two or more levels of detail comprise at least a low-level of detail wherein only the total income, the total spending and surplus or deficit of the net worth is displayed in the graphical user interface.

According to a possible implementation, the levels of detail comprise a high-level of detail wherein all sources of financial data used to calculate the total income and the total spending are displayed in the graphical user interface.

According to a possible implementation, the financial projection comprises a cash flow projection. According to a possible implementation, the financial projection comprises a balance or net worth projection, including a value of the estate at an assumed death time of the individual, the financial data gathered further comprising asset data and liability data.

According to a possible implementation, wherein gathering the financial data comprises accessing financial data from accounts linked to the individual or one of its entities.

According to a possible implementation, the graphical user interface comprises means to select one or more entities associated with the individual, including: the individual itself, other individuals such as spouses, children or partners, and/or companies, the method comprising: capturing a selection of the one or more entities from the graphical user interface; calculating the first and second scenarios of cash flow projection for the entities captured, based on their respective financial data; and displaying the first and second scenarios of cash flow projections for the selected entities on the graphical user interface.

According to a possible implementation, the method comprises displaying a set of number values or a graph of the sums resulting from combining the values of the different accounts for the entity(ies) selected, at a given point in time or over a given time period.

According to a possible implementation, the method comprises periodically recalculating the financial projection and indicator according to a given one of the scenarios selected for the individual, using the most recent assumptions and/or financial data available for the individual; and when the indicator falls below a predetermined threshold, determining one or more variations of at least one of: the time or the financial parameters of the goal(s), the income data or the expense data, where the one or more variation(s) will increase the likelihood of achieving the initial or modified life goals; generating a financial advice based on the one or more variation(s) determined; and notifying the individual or a financial advisor of the advice via an electronic communication.

According to a possible implementation, the change(s) determined comprise(s) at least one of: a reduction of expenses, an increase in incomes and/or a delay in an estimated retirement date.

According to a possible implementation, the method comprises calculating a first set of values of the net worth of the individual as a function of time, based on one of the scenarios, said scenario based in part on a first assumption value relating to retirement expenses, identifying a first year in which the value of the net worth decreases from positive to negative; capturing from the graphical user interface a variation on an assumption value relating to retirement expenses; calculating a second set of values of the net worth of the individual as a function of time based on the variation on the assumption value; identifying a second year in which the value of the net worth decreases from positive to negative; and displaying on the graphical user interface the first year and the second year in conjunction with the first assumption relating to retirement expenses and the variation in a graph or as a set of values.

According to a possible implementation, the method comprises calculating a plurality of updated values of the net worth associated with a plurality of variations of the assumption value relating to retirement expenses, and displaying the plurality of updated values of the net worth at the estimated year of retirement.

According to a possible implementation, a computer method for predicting the probabilities that life goals set for an individual will be achieved is provided. A goal entry comprises time parameters and financial parameters. The method comprises gathering financial data and at least one of: personal information data, socioeconomic data and behavioral data associated with the individual; feeding the gathered data to a plurality of machine learning models, each having been specifically trained and configured to predict the probability that a given goal will be achieved; and outputting the predicted probability associated with each goal, indicative of whether the respective life goals are likely to be achieved.

According to a possible implementation, a method for training a machine learning model in determining the likelihood that a goal set by an individual will be achieved. The method comprises collecting for a plurality of individuals, financial data and at least one of: personal information data, socio-economic data and behavioral data; generating a training dataset by labelling the collected data for the plurality of individuals with respective indications of whether or not the individuals have achieved the goal; training a goal achievement machine learning model using the training dataset to predict the probability that a given individual will achieve the goal set, using as an input their financial data and at least one of their personal information data, socioeconomic data and behavioral data.

According to a possible implementation, a system for generating an indicator of the likelihood that an individual will achieve one or more life goals is provided. The system comprises an input module for receiving data indicative of the one or more life goals and life events associated with the individual, each life goal or life event comprising at least one of a time parameter and a financial parameter; connectors for connecting to a plurality of financial data sources and for gathering the financial data associated with the individual, the financial data comprising income data and expense data associated with the individual or with entities relating to the individual; a financial projection and indicator calculation module for calculating a financial projection according to a given scenario, the given scenario being a function of the financial data gathered; and being a function of a set of assumption values that determines projected incomes and projected expenses; and calculating the indicator of the likelihood that the individual will achieve the life goal(s) according to the given scenario, based on the financial projection calculated; a graphical user interface for capturing the set of assumption values and for displaying the indicator.

According to a possible implementation, the system comprises a Monte Carlo module comprising a set of computational algorithms for calculating the indicator based on Monte Carlo simulations.

According to a possible implementation, the system comprises a data storage for storing the data indicative of the one or more life goals and for storing respective weight values associated therewith, and wherein the calculation module is configured to calculate the indicator as a function of the different weights associated with the life goals.

According to a possible implementation, in the data storage module, the data indicative of a goal is associated with different goal types, such as needs, projects and dreams, and wherein the weight associated with a need is higher than the weight associated with a project or a dream.

According to a possible implementation, the weight associated with a goal is further based on a degree of commitment associated with said goal, the system further comprising machine learning models trained to predict the degree of commitment associated with a given goal using the gathered financial data, including spending and/or saving habits identified therefrom.

According to a possible implementation, different machine learning models are trained for different life goals, the machine learning models being provided with the gathered financial data and at least one of: personal information data, socio-economic data and behavioral data, to determine the respective predicted probability associated with the one or more life goals.

According to a possible implementation, the system comprises, the connectors are adapted to connect to databases to access financial data from accounts linked to the individual or one of its entities.

According to a possible implementation, a computer implemented method for generating customized financial products is provided, that allow individuals to achieve their respective life goals.

According to a possible implementation, the method comprises acquiring or determining cash flow and financial projections that are based on financial data associated with an individual and on life goals set for the individual, each life goal comprising time parameter(s) and financial parameter(s)(s), the financial data and life goals being stored in one or more databases; acquiring or calculating, using processing devices, an indicator of the likelihood that the individual will achieve the life goal(s) according to a given scenario, based on the cash flow and financial projections; determining, by the processing devices, a period where the net cash flow is negative and/or where the indicator is below a given threshold; evaluating or generating financial products that allow the cash flow to stay positive for the period; recalculating, by the processing devices, the cash flow projections and the indicator by including the financial product(s); and offering, by displaying or by sending an electronic notification to an electronic device, the financial product(s), if it allows to bring the indicator above a determined threshold.

According to a possible implementation, means are provided to schedule the offer for the financial products at a time sufficiently in advance of the period where the net cash flow is determined as negative.

According to a possible implementation, the financial product is a customized loan offer. The step of evaluating or generating the financial products comprises determining a loan amount and interest rate that allows the cash flow to stay positive for the period. The method may further comprise recalculating, by the processing devices, the cash flow projections and the indicator by including the loan at the given interest rate and offering the customized loan if the indicator value raises above a determined threshold.

According to a possible implementation, the step of recalculating the cash flow projections and the indicator comprises iteratively varying the interest rate from an initial interest rate to a proposed interest rate, until the indicator value is above the determined threshold.

According to a possible implementation, the initial interest rate corresponds to a posted interest rate and the proposed interest rate is lower that the posted interest rate but above a pre-set floor value.

According to a possible implementation, the financial product is a customized insurance product and wherein the individual has a spouse who generates revenues for their household. The step of determining the period where the net cash flow is negative and/or where the indicator is below a given threshold is performed according to a first scenario where the spouse ceases to generate revenue for the household at a given year Y before the assumed year of death of the individual, the cash flow projection being recalculated for each year between year Y and the assumed year of death. The step of evaluating or generating the customized insurance product comprises: determining an insurance pay-out that corresponds to the net present value needed for indicator to stay above a given threshold and/or for the net cash flow to stay positive each year until the assumed year of death; and determining associated monthly payments for the insurance pay-out, the monthly payment varying according to the net present value needed for a given month.

According to a possible implementation, the method comprises performing the previous steps for the spouse, according to a second scenario where the individual passes away at year Y before the assumed year of death of the spouse, the method comprising determining distinct insurance pay-outs and/or monthly payments for the individual and his/her spouse, depending on who passes away first.

According to a possible implementation, the method comprises calculating the cash flow projection and the indicator of the individual for each year from i) year Y corresponding to the spouse ceasing to generate revenues and ii) the assumed year of death of the individual by removing the spouse's projected revenues; calculating the cash flow projection and the indicator of the individual for each year from i) year Y corresponding to the spouse ceasing to generate revenues and ii) the assumed year of death of the individual by removing the spouse's projected revenues and by adding the insurance payout of the individual's life insurance; identifying the first year in which values of the indicator calculated in step a) and the indicator calculated in step b) are both above a given threshold, this first year corresponding to the year the individual is self-funded from his investment returns and no longer needs life insurance.

According to a possible implementation, the customized financial product corresponds to the identification of an investment property. The method comprises obtaining from one or more databases property-related information for a plurality of investment properties for sale; calculating, by the processing devices, real estate return projections for each of the investment properties; recalculating by the processing devices the cash flow projections and the indicator of the individual by including, for each of the investment properties, the real estate return projection associated to said property; identifying the investment property that generates the highest indicator value; and displaying or sending a notification including the investment property and associated indicator.

According to a possible implementation, the property-related information comprises an estimated purchase price, estimated annual maintenance costs, rental incomes, location and building type.

According to a possible implementation, the financial product is a customized home equity line of credit (HELOC), and wherein the step of evaluating or generating the financial products comprises determining whether the individual is within N years of retirement; simulating, by the processing device, a market downturn by recalculating the cash flow projection and indicator for the individual using an investment return corresponding to a given drop in the market; determining, by the processing devices, a period where the net cash flow is negative and/or where the indicator is below a given threshold; accessing databases to verify whether the individual owns a property with capital build-up on the property; calculating an amount that allows the cash flow to stay positive for the period and/or that allows the indicator to stay above a predetermined threshold; and offering a HELOC corresponding the amount calculated if the amount of the property build-up is greater than the amount calculated.

1. A computer-implemented method for generating an indicator of the likelihood that an individual will achieve his financial goals, the method comprising:
receiving at a communication interface of a computer-implemented simulation system, an electronic request from a financial planning application running on a remote device for financial projection data based on the financial goals of the individual and for the associated indicator;
upon receiving the electronic request, retrieving via a querying module of the computer-implemented simulation system, from a data storage:
financial goal entries associated with the individual, each financial goal entry comprising a time value and a financial value characterizing an expense associated with the financial goal, and
a set of assumption values that determine projected incomes and projected expenses of the individual;
retrieving, via connectors of the computer-implemented simulation system in communication with different data sources, financial data associated with the individual, the financial data comprising current account balances, historical income data and historical expense data;
concurrently simulating, by one or more processing devices of the computer-implemented simulation system, a plurality of financial projections over a given time interval, the financial projections being simulated using the time and financial values of the financial goal entries and using the financial data retrieved from the different data sources, each financial projection being simulated by applying a variation on the set of assumptions values;
determining, by the one or more processing devices, for each financial projection of the plurality of financial projections, whether a net balance is positive or negative over all periods of the time interval;
calculating, by the one or more processing devices, the indicator of the likelihood that the individual will achieve the financial goals, based on the plurality of financial projections simulated, the indicator being indicative of a number of financial projections simulated for which the net balance is positive, over the plurality of financial projections simulated; and
outputting, via the communication interface of the computer-implemented simulation system, the indicator and the financial projection data combining the plurality of financial projections simulated to the financial planning application of the remote device, for display in a graphical user interface on the screen of the remote device.

2. The computer-implemented method according to claim 1, wherein the indicator is expressed as a percentage or a ratio of the number of financial projections for which the net balance is positive, over the plurality of financial projections simulated.

3. The computer-implemented method according to claim 1, wherein the given time interval spans over several years; wherein simulating the plurality of financial projections is performed for each year of the time interval; and wherein for a given year, the financial value of one of the financial goal entries is added to the financial projection simulations if the time value of said one entry falls within the given year.

4. The computer-implemented method according to claim 3, wherein applying the variations on the set of assumptions values is performed using a Monte Carlo simulation.

5. The computer-implemented method according to claim 4, comprising retrieving from the data storage, weights associated with the financial goal entries, and wherein simulating the financial projections comprises adjusting the financial values associated with the financial goal entry as a function of the weight of said entry.

6. The computer-implemented method according to claim 5, wherein the financial goal entries are classified according to different goal types, each goal type being associated with a corresponding weight.

7. The computer-implemented method according to claim 6, comprising associating, by the one or more processing devices, indicator thresholds with the different goal types, the indicator being expressed as a joint probability that all indicator thresholds will be met for the financial goals entries.

8. The computer-implemented method according to claim 6, wherein the weight associated with a financial goal entry is based on a degree of commitment associated with said financial goal, the degree of commitment being determined by the one or more processing devices of the computer-implemented simulation system, based on the historical income data and historical expense data.

9. The computer-implemented method according to claim 8, wherein determining the degree of commitment associated with the financial goals is performed using a trained machine learning model, the degree of commitment corresponding to a predicted probability outputted by the trained machine learning model that a specific financial goal will be achieved, the historical income data and historical expense data being inputted to the trained machine learning model.

10. The computer-implemented method according to claim 1, wherein the set of assumption values is associated with a first scenario, the method further comprising:
displaying, by the financial planning application of the remote device, in the graphical user interface, a graph representative of the combined financial projections simulated and associated with the first scenario;
capturing by the financial planning application of the remote device, via the graphical user interface, a selection of a second scenario, the second scenario comprising a change in at least one of the assumption values of the set of assumption values associated with the first scenario;
sending by the financial planning application of the remote device to the computer-implemented simulation system, an updated electronic request for updated financial projection data and for an updated indicator;
upon receiving the updated electronic request, the computer-implemented simulation system automatically re-simulating the financial projections according to the second scenario and updating the indicator; and
outputting, via the communication interface of the computer-implemented simulation system, the updated indicator and the updated financial projection data to the financial planning application of the remote device;
displaying by the financial planning application of the remote device, in the graphical user interface, the graph of the first scenario and a graph of the second scenario, as well as the updated indicator, indicating the effect of the second scenario on the likelihood of achieving the financial goals.

11. The computer implemented method according to claim 10, wherein the change comprises changing at least one of: an investment return rate; a risk profile associated with the individual; a retirement date and a life expectancy.

12. The computer implemented method according to claim 11, comprising:
capturing by the financial planning application of the remote device, via the graphical user interface, a variation interval to use when applying the variations on the set of assumptions values, the variation interval comprising a lower bound and an upper bound determining the scope of the variations to apply when simulating the financial projections, and
simultaneously displaying on the graphical user interface, the effect of the variation interval on the first or second scenarios for which the variation interval has been captured, while still displaying the initial first and second scenarios.

13. The computer implemented method according to claim 1, wherein the financial projections simulated comprises cash flow projections and/or a balance or net worth projections, and wherein the net balance corresponds to a value of the estate at an assumed year of death of the individual.

14. The computer implemented method according to claim 1, comprising:
determining by the one or more processing devices, for years of the time interval during which the net balance is negative, a modification to the time or the financial values of the financial goal entries, the projected incomes or the projection expenses, that will increase a value of the indicator;
generating by the one or more processing devices, a financial advice based on the modification determined; and
sending an electronic notification to the financial planning application of the remote device comprising the financial advice.

15. The computer implemented method according to claim 14, wherein:
generating the financial advice comprises automatically determining a loan amount and interest rate that allow the simulated financial projections to remain positive for all years of the given period.

16. A system for generating an indicator of the likelihood that an individual will achieve his financial goals, the system comprising:
a computer-implemented simulation system comprising one or more processing devices; a communication interface for communicating with financial planning applications running on remote devices, a querying module in communication with a data storage; connectors in communication with different data sources; the computer-implemented simulation system being adapted to:
receive at the communication interface electronic requests from the financial planning applications running on the remote devices, for financial projection data based on financial goals of a plurality of individuals and for corresponding indicators;
upon receiving the electronic request, retrieve via the querying module, from the data storage:
financial goals entries associated with each individual, each financial goal entry comprising a time value and a financial value characterizing an expense associated with the financial goal, and
a set of assumption values that determine projected incomes and projected expenses of the individual;
retrieve, via the connectors, financial data associated with each individual, the financial data comprising current account balances, historical income data and historical expense data;
concurrently simulate, by one or more processing devices, a plurality of financial projections over a given time interval, the financial projections being simulated using the time and financial values of the financial goal entries and using the financial data retrieved from the different data sources, each financial projection being simulated by applying a variation on the set of assumptions values;
determine, by the one or more processing devices, for each financial projection of the plurality of financial projections, whether a net balance is positive or negative over all periods of the time interval for each individual;
calculate, by the one or more processing devices, the indicator of the likelihood that the individual will achieve the financial goals, based on the plurality of financial projections simulated, the indicator being indicative of a number of financial projections simulated for which the net balance is positive, over the plurality of financial projections simulated; and
output, via the communication interface, the indicators and the financial projection data combining the plurality of financial projections simulated to the financial planning applications of the remote device for the individuals, for display in graphical user interfaces on the screens of the remove devices.

17. The system according to claim 16, wherein the computer-implemented simulation system comprises a Monte Carlo module comprising a set of computational algorithms for simulating the plurality of financial projections for the plurality of individuals.

18. The system according to claim 16, comprising the data storage for storing the financial goal entries of a plurality of individuals and for storing respective weight values associated therewith, and wherein the computer-implemented simulation system is configured to calculate the indicator as a function of the different weights associated with the financial goals entries.

19. The system according to claim 18, comprising:
a machine learning model trained to determine a degree of commitment associated with the financial goals by outputting a predicted probability that a specific goal will be achieved, the historical income data and historical expense data being inputted to the trained machine learning model,
wherein the computer-implemented simulation system is configured to simulate the financial projections further based on the degree of commitment associated with the financial goals.

20. The system according to claim 18, comprising the plurality of remote devices running the financial planning applications, the remote devices being configured to:
display, on a corresponding one of the remote devices, a graph representative of the set of financial projections associated with a first scenario, the set of assumption values being associated with the first scenario;
receive a selection of a second scenario, the second scenario comprising a change in at least one of the assumption values of the set of assumption values associated with the first scenario;
the computer-implemented simulation system being configured to automatically re-simulate the financial projections according to the second scenario and update the indicator; and
the remote devices being further configured to display the graph of the first scenario and a graph of the second scenario in the graphical user interface, as well as the updated indicator.

21. The system according to claim 20, wherein each of the remote devices is configured to capture a variation interval associated with the first or second scenarios, the variation interval comprising a lower bound and an upper bound, and wherein each remote device is configured to simultaneously display the effect of the variation interval on the scenario for which the variation has been captured, while still displaying the initial first and second scenarios.

22. The system according to claim 21, wherein the computer-implemented simulation system is configured to determine, for years during which the indicator falls below a predetermined threshold, a modification to the time or the financial values of the financial goal entries, the projected incomes or the projection expenses, that will increase the likelihood of achieving the finance goals;
the computer-implemented simulation system further comprising:
a finance advice module configured to generate financial advice based on the change(s) determined; and
a notification module for sending an electronic notification to the financial planning application of the remote device comprising the financial advice.
